(19) United States
(12) Patent Application Publication
(10) Pub. No.: US 2003/0154931 A1
(43) Pub. Date: Aug. 21, 2003

(54) Vinyl bag package and storage device therefor

(76) Inventor: Morris Ostrowiecki, Tokyo (JP)

Correspondence Address: MORRIS OSTROWIECKI, 5-10-20 MINAMI AOYAMA, MINATO-KU, TOKYO, 107-0062, JP

(21) Appl. No.: 10/076,518

(22) Filed: Feb. 19, 2002

(51) Int. Cl. A01K 27/00; A01K 29/00

(52) U.S. Cl. 119/796; 206/554; 294/1.3

(57) ABSTRACT

A poly back pack is disclosed comprising a plurality of folded poly bags wrapped in a thin film cover, the cover having an opening for allowing the folded poly bags to be sequentially pulled out therethrough, the folded poly bags being joined to each other and having perforated lines between poly bags for allowing said poly bags to be easily seperated from each other, the poly bags partially unfolding along the length thereof as they are being pulled out of the cover. Further disclosed is a poly bag pack which comprises a plurality of folded poly bags wrapped in a thin film cover, the cover having an opening for allowing the folded poly bags to be sequentially pulled out therethrough, the folded bags being stacked on top of each other, each folded bag having a portion thereof tucked into an adjacent folded bag, so that when one bag is pulled out of the pack, the adjacent bag to the bag being pulled is also partially pulled out of the pack. Further disclosed is a poly bag pack storage dispensing device for storing the pack of poly bags in one compartment thereof and for sequentially dispensing the poly bags through another compartment thereof. In one embodiment, the storage dispensing device in integrally formed with a dog leash storage-dispensing apparatus. Further disclosed is a pooper scooper for picking up dog excrement.

### BACKGROUND OF THE INVENTION

The present invention relates to a method of storing vinyl bags, so that they require very little physical space and so that they can be easily drawn out of the storing package one at a time. Also, a storage device for storing a packet of vinyl bags as well as for allowing for the sequential removal of each stored vinyl bag is disclosed. Also disclosed is a dog pooper-scooper for picking up dog excrement in combination with a poly bag.

Presently, there are many types and sizes of vinyl bags (hereinafter also referred to as poly bags or disposable bags or simply bags). Also, the most common way of storing these bags is on a roll, similar to the way toilet paper is stored on a roll. These poly bags, although joined together to each other, can be easily separated from each other owing to the perforations between adjoining poly bags. These bags are commonly available in supermarkets for buyers to tear of one bag at a time and are generally used for placing vegetables in.

It is not always convenient to have these vinyl bags stored in roll form from a space point of view. This is especially true for people who have dogs. Many people use poly bags to pick up their dog's litter. Usually, people carry a poly bag in their pocket when walking their dog. However, should they forget to bring a poly bag with them, it could create a very cumbersome and embarrassing situation. There are many products available on the market but none of them solve this problem elegantly, conveniently and cheaply.

### SUMMARY OF THE INVENTION

A major object of the present invention is to overcome the drawbacks mentioned above.

Another object of the present invention is to provide a vinyl packet containing a plurality of vinyl bags and a method of making the same, the vinyl bags in said packet being folded in such a way that pulling out one bag causes the bag adjacent to it to be partly pulled out as well, so that it is ready to be pulled out the next time the user needs a poly bag, said vinyl bags being joint to each other and having perforated lines therebetween, so that each bag can be easily separated from the one next to it.

Another object of the present invention is to provide a vinyl packet containing a plurality of vinyl bags and a method of making the same, the vinyl bags in said packet being folded in such a way that pulling out one bag causes the bag adjacent to it to be partially pulled out as well, so that it is ready to be pulled out the next time the user needs a poly bag.

Another object of the present invention is to provide a vinyl packet containing a plurality of vinyl bags and a method of making the same, whereby each bag in said packet can be sequentially pulled out of said packet, each bag in said packet being folded at least once along the length thereof and at least once along the width thereof, said bags in said pocket being joined to each other and having perforated lines therebetween for facilitating the easy tearing of each bag from the one adjacent to it.

Another object of the present invention is to provide a vinyl packet containing a plurality of vinyl bags and a method of making the same, whereby each bag in said packet can be sequentially pulled out of said packet, each bag in said packet being folded at least once along the length thereof and at least once along the width thereof, said bags in said pocket being joined to each other and having perforated lines therebetween for facilitating the easy tearing of each bag from the one adjacent to it, each of the bags being pulled out of said packet coming out of said packet with the open side thereof coming out first, thereby facilitating for the easy use thereof.

Another object of the present invention is to provide a vinyl packet containing a plurality of vinyl bags and a method of making the same, each of the bags in said pocket being folded in such a way that when one bag is manually pulled out, the adjacent bag is also partially pulled out, whereby, the adjacent bag partially sticks out of the packet, so that it is ready to be pulled out the next time the user needs a bag.

Another object of the present invention is to provide a vinyl packet containing a plurality of vinyl bags and a method of making the same, said vinyl bags being folded in such a way that they take up a relatively small surface area when compared to their unfolded size and each of the bags in said pocket being folded in such a way that when one bag is manually pulled out, the adjacent bag is also partially pulled out, so that it is ready to be pulled out the next time the user needs a bag.

Another object of the present invention is to provide a vinyl packet containing a plurality of vinyl bags and a method of making the same, said vinyl bags being folded in such a way that they take up a relatively small surface area when compared to their unfolded size and each of the bags in said pocket being folded in such a way that when one bag is manually pulled out, the adjacent bag is also partially pulled out, so that it is ready to be pulled out the next time the user needs a bag, each bag being pulled out having its open end come out first from the inside of said packet.

Another object of the present invention is to provide a vinyl packet containing a plurality of vinyl bags and a method of making the same, said vinyl bags being folded at least twice along the length thereof and at least three times along the width thereof, said folded bags being stacked on top of each other in such a way that when one bag is manually pulled out, the adjacent bag to the bag being pulled out is also partially pulled out, so that it is ready to be pulled out the next time the user needs a bag, each bag being pulled out of said packet having its open end come out first from the inside of said packet.

A further object of the present invention is to provide a poly bag storage-dispensing device for storing a packet containing a plurality of vinyl bags in one compartment thereof and for allowing for the dispensing of said vinyl bags sequentially from another compartment thereof.

Another object of the present invention is to provide a poly bag storage dispensing device which comprises three portions and two hinges integrally formed with said portions, said three portions defining two compartments, one compartment for storing a vinyl bag pack and the other compartment for storing the extending end of the next available vinyl bag, said case being formed using conventional plastic injection molding techniques.

Another object of the present invention is to provide a dog leash storage extension apparatus having a poly bag pack storage-dispensing device integrally formed therewith.

Also, disclosed is a pooper-scooper for picking up pet litter, which is very thin and compact, so the owner of the pet need not feel the litter through the vinyl bag when he or she is picking up the litter by hand.

### BRIEF DESCRIPTION OF THE DRAWINGS

FIG. 1 shows a side view of a conventional roll of poly bags;

FIG. 2 shows a front view of the conventional poly bags of FIG. 1;

FIG. 3 shows a front view of the poly bags of FIG. 2 after being folded twice along the length thereof at dash and dot lines designated by symbols J-K;

FIG. 4 shows a cross sectional view at line I-I of FIG. 3;

FIG. 5 shows the same view as FIG. 4 but showing the poly bag in line form to simplify the drawing thereof;

FIG. 6 shows a side view of a folded poly bags 20 of FIG. 3 further being folded sequentially up and down five times as designated by symbols U and D, respectively;

FIG. 7 shows a perspective view of the vinyl bags of FIG. 2 in a three-dimensional Cartesian mathematical representation system for facilitating the explanation of the folding steps of the vinyl bags;

FIGS. 8A-8C show a perspective view, an end view and a front view of the vinyl bags 20 of FIG. 2 after being folded as shown in FIG. 5 and FIG. 6 and then being wrapped and sealed inside a vinyl cover 30;

FIGS. 9A-9H show a front view of a vinyl bag 10 being folded twice along the width thereof and 5 times along the length thereof;

FIGS. 9I-9K show an end view of the bag 10 of FIGS. 9A-9C, respectively;

FIG. 9L shows an end view of the bags 10 being folded 5 times up and down along the length thereof;

FIG. 9M shows a side view in line form of three poly bags 10 which have been folded twice along the width thereof and then 5 times along the length thereof, each bag 10 having a part thereof tucked inside the bag 10 adjacent to it;

FIG. 9N shows a side view in line form of three poly bags 10 which have been folded twice along the width thereof and then 4 times along the length thereof, each bag 10 having a part thereof tucked inside the bag 10 adjacent to it;

FIG. 9O shows a front view of a sheet of vinyl 9 for covering the plurality of vinyl bags shown in FIG. 9M or 9N to form a packet of vinyl bags according to the present invention;

FIG. 9P shows a side view of the vinyl sheet 9 of FIG. 9O;

FIG. 9Q shows the sheet of vinyl 9 of FIG. 9O after being folded over the plurality of vinyl bags of FIG. 9M or 9N to form a packet of vinyl bags 400 according to the present invention;

FIG. 10A shows a perspective view of a storage-dispensing device 50 for housing a pack of poly bags 40 therein and for sequentially dispensing the poly bags 20 stored in the pack 40 one at a time, the device being in a closed position;

FIG. 10B shows a cross sectional view at line I-I of FIG. 10A of the storage-dispensing device, the device being in a closed position;

FIG. 10C shows a cross sectional view at line I-I of FIG. 10A of the storage-dispensing device, the device having the cover portion thereof in the open position;

FIG. 10D shows a cross sectional view at line I-I of FIG. 10A of the storage-dispensing device 50, with the cover and divider portions thereof in the open position;

FIG. 10E shows a top view of the storage-dispensing device with the cover and divider portions thereof in the open position;

FIG. 10F shows a bottom view of the storage-dispensing device 50 with the cover and divider portions thereof in the open position;

FIG. 10G shows a cross sectional view at line I-I of FIG. 10A of the storage-dispensing device, the device being in a closed position and having a pack of poly bags 40 stored therein according to the present invention;

FIGS. 11A-11B show side cross sectional views of a poly bag storage dispensing device 500 according to the present invention, with the cover 52 and divider 53 portions thereof in the closed and open position, respectively;

FIG. 12A shows a perspective view of a poly bag pack storage dispensing device 5000 according to another embodiment of the present invention;

FIG. 12B shows a cross sectional view at line I-I of FIG. 12A with the cover portion 52 in the closed position and the divider portion thereof inserted;

FIG. 12C shows an end cross sectional view at line I-I of FIG. 12A with the cover portion 52 thereof in the open position and the divider portion thereof removed;

FIG. 12D shows a top view of the divider portion 5300 according to the present invention;

FIG. 13A shows a perspective view of a poly bag pack storage dispensing device 60 according to another embodiment of the present invention;

FIG. 13B shows a side cross sectional view at line I-I of the device 60 of FIG. 13A in a closed position and with a divider portion 63 mounted therein;

FIG. 13C shows a side cross sectional view at line I-I of the device 60 of FIG. 13A in an open position and with a divider portion 63 removed;

FIG. 13D shows a top view of the device 60 in the open position and with the divider 63 removed;

FIGS. 13E and 13F show a top view and an end view of the divider 63 according to the present invention;

FIG. 14 shows a perspective view of the poly-bag-pack-storage-dispensing apparatus 50 of the present invention mounted on one side of a conventional dog leash storage-extension apparatus 11;

FIG. 15A shows a perspective view of a dog leash storage extension apparatus 15 having the poly bag pack storage dispensing device integrally formed therewith according to the present invention;

FIG. 15B shows a side cross sectional view of the apparatus at line I-I of FIG. 15A with the cover section 52 thereof in the closed position;

FIG. 15C shows a side cross sectional view of the apparatus at line I-I of FIG. 15A with the cover section 52 thereof in the open position;

FIG. 15D shows a front view of the dog leash storage extension apparatus 15 without the cover section 52 mounted thereon;

FIG. 15E shows a bottom view of the cover section 52;

FIGS. 15F and 15G show side cross sectional views of the cover portion only at line I-I of FIG. 15A, the covers portion being in the closed and open positions, respectively;

FIG. 15H shows an inside view of a dog leash storage extension apparatus 15 having the poly bag pack storage dispensing device integrally formed therewith as well as a particular structure for the dog leash extension/retraction apparatus according to the present invention;

FIG. 15I shows an end view of a pulley 82 used in the dog leash extension/retraction apparatus shown in FIG. 15H;

FIG. 15J shows a front view of the pulley 82 having a wind up spring 85 mounted therein;

FIG. 15K shows a back view of the pulley 82;

FIG. 15L shows a cross sectional view at line III-III of FIG. 15 of the pulley 82, without the wind up spring 85 mounted therein;

FIG. 15M shows a cross sectional view at line II-II of FIG. 15H;

FIG. 15N shows a cross sectional view at line I-I of a dog leash storage extension apparatus 150 having the poly bag pack storage dispensing device integrally formed therewith according to another embodiment of the present invention;

FIG. 16A shows a perspective view of a dog excrement scooper 69 for picking up dog excrement according to the present invention;

FIGS. 16B and 16C show an end view and front view of the scooper 69 of FIG. 16A;

FIG. 16D and FIG. 16E show a front view and an end view of a dog excrement scooper 690 having the profile of a dog on a pair of skates according to the present invention;

FIG. 16F shows a perspective view of a scooper support 79 according to the present invention;

FIG. 16G shows an end view of the scooper support 79 supporting the scooper 69 therein;

FIGS. 16H and 16I show a front view and an end view of a scooper 89 according to another embodiment of the present invention;

FIG. 16J shows a front view of a scooper 99 according to another embodiment of the present invention;

FIGS. 16K-16L show end views of the scooper 99 of FIG. 16J in its natural state and in a pressed state;

FIG. 16M shows a front view of a pooper scooper 101 according to another embodiment of the present invention;

FIG. 17A shows a front perspective view of a storage-dispensing device according to another embodiment of the invention;

FIG. 17B shows a back perspective view of the storage-dispensing device of FIG. 17A;

FIG. 17C shows a cross sectional view at line I-I of FIG. 17A of the storage-dispensing device, the device being in a closed position;

FIG. 17D shows a cross sectional view at line I-I of FIG. 17A of the storage-dispensing device, with the cover and divider portions thereof in the open position;

FIG. 17E shows a top view of the storage-dispensing device with the cover and divider portions thereof in the open position; and

FIG. 17F shows a bottom view of the storage-dispensing device 90 with the cover and divider portions thereof in the open position;

FIG. 18 shows a perspective view of the poly bag pack storage-dispensing device 620 having a pooper scooper support integrally formed therewith and having the pooper scooper apparatus shown in FIG. 16D mounted therein.

### DETAILED DESCRIPTION OF THE PREFERRED EMBODIMENTS

A plurality of folded poly bags are stored in a relatively smaller poly bag cover.

The plurality of poly bags are stored in one of two ways. One way is by having them joined to each other with perforations in between poly bags and the other is by having them totally separated from each other.

Basically, two types of poly bag packs are disclosed. One type of pack has a plurality poly bags stored in a cover, the poly bags being joint to each other and have perforations formed between adjacent poly bags (hereinafter referred to as joint poly bags or simply joint bags), so that the bags may be easily separated (i.e. torn) from each other, the poly bags inside the cover being folded in such a way that, not only do they require a much smaller surface area, but also in a way that the poly bags can be sequentially pulled out of the cover through an opening in the cover and can easily be separated from each other by simply pulling on both sides of the perforated lines, whereby, the next bag is partially exposed out of the cover, so that it is easily accessible next time the user needs a poly bag. The cover is made of a sheet of thin film similar to the poly bags, the sheet of film being wrapped around the folded poly bags along the length direction of the film and then being heat sealed along the folded sides thereof, so that the folded poly bags inside the cover can be pulled out through the remaining open slot in the cover.

The other type of pack has a plurality of poly bags which are not joint to each other (i.e. hereinafter referred to as separate poly bags or separate bags) stored in a cover, the poly bags inside the cover being folded in such a way that not only do they require a much smaller surface area but also enable the function of when one poly bag is pulled out through an opening in the cover, a small part of an adjacent poly bag is also pulled out of the cover, so that it is easily accessible next time the user needs to use a poly bag. This is partly accomplished by having a part of each folded poly bag also being partly tucked inside an adjacent folded poly bag. The cover is the same as the cover described above.

In both types of packs, the open side of each poly bag is the first part to come out of the pack. Both types of packs have a plurality of bags, preferably between 30 and 50 poly bags stored therein. The size of each bag preferably is around 25 cm. wide and 30 cm. long. This size of bags is a good size for most people to use for picking up dog excrement, since these bags are wide enough to allow people to spread their fingers apart inside these bags and long enough to allow people to turn these bags inside out while holding on to the dog excrement and need not worry about coming into physical contact with the dog excrement.

The poly bags inside each pack can be folded manually or by using special folding machines such as disclosed in U.S. Pat. No. 4,744,673, the subject matter of which is incorporated herewith.

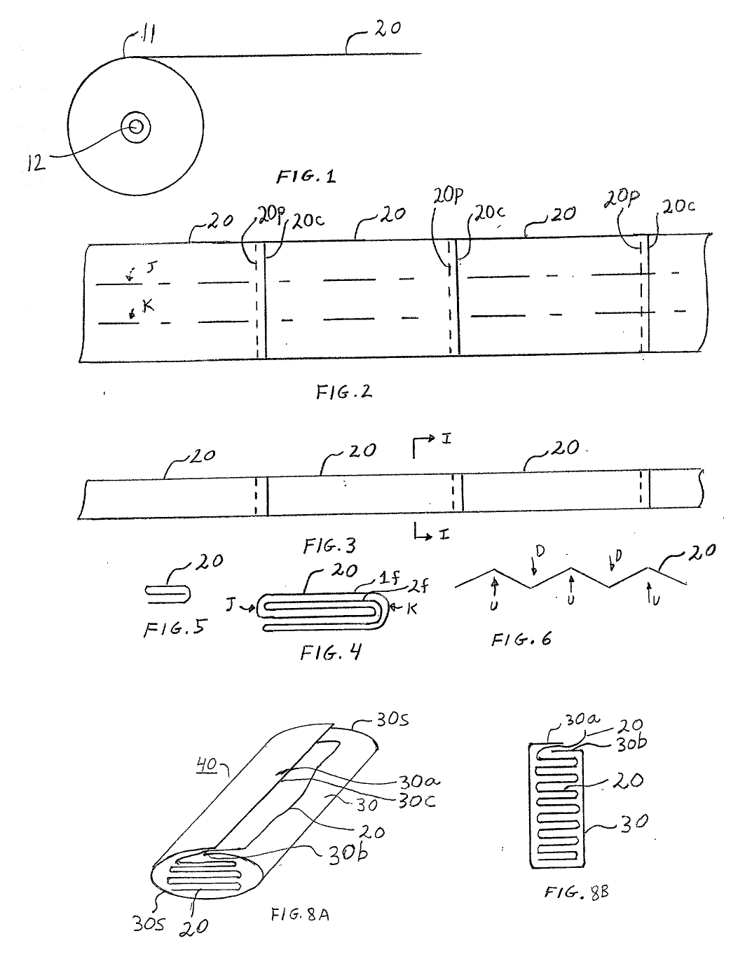

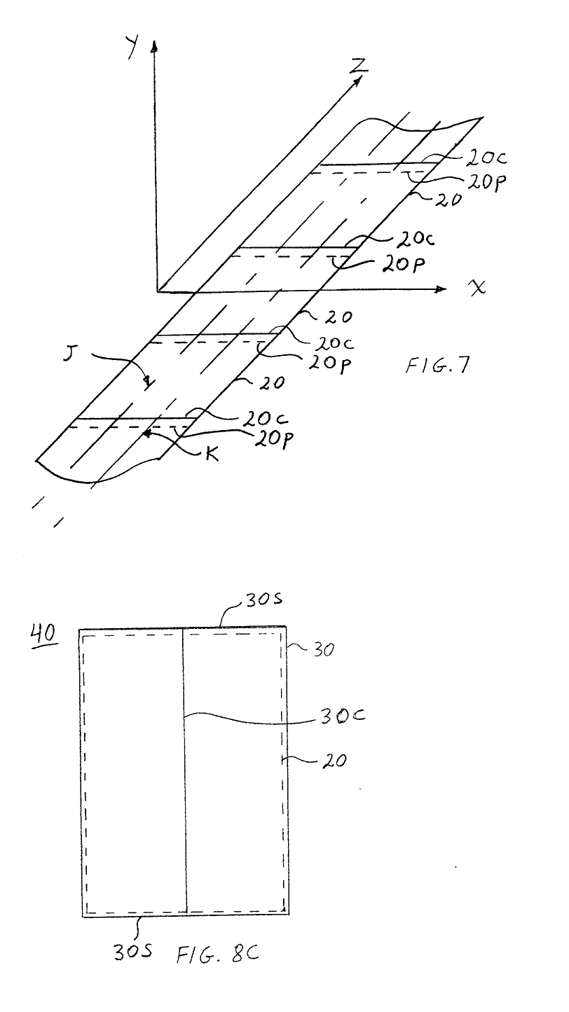

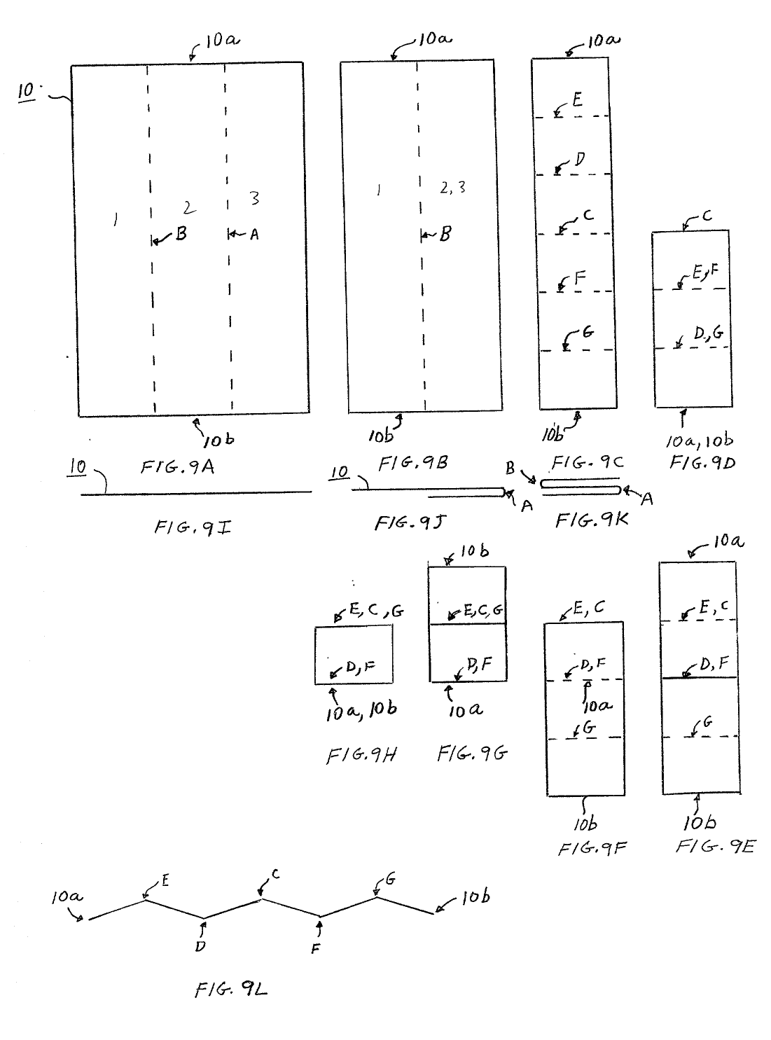

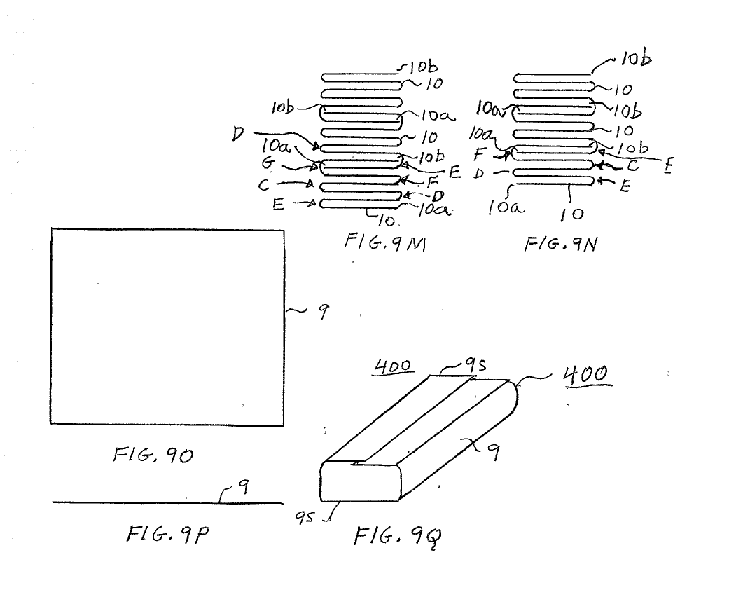

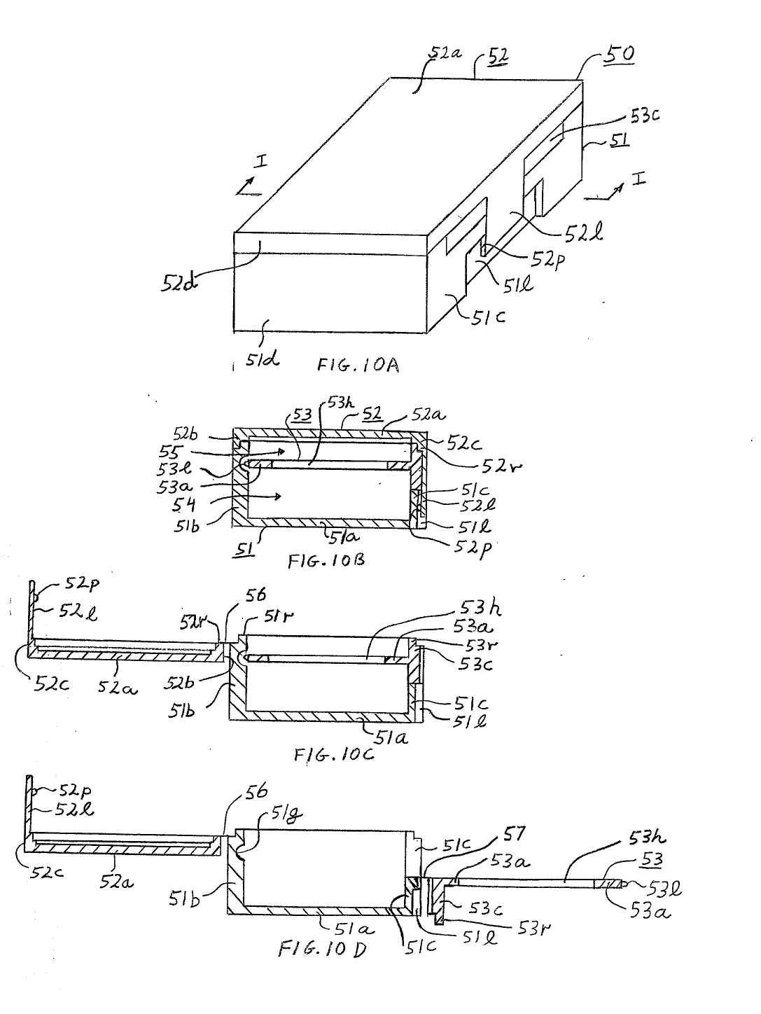

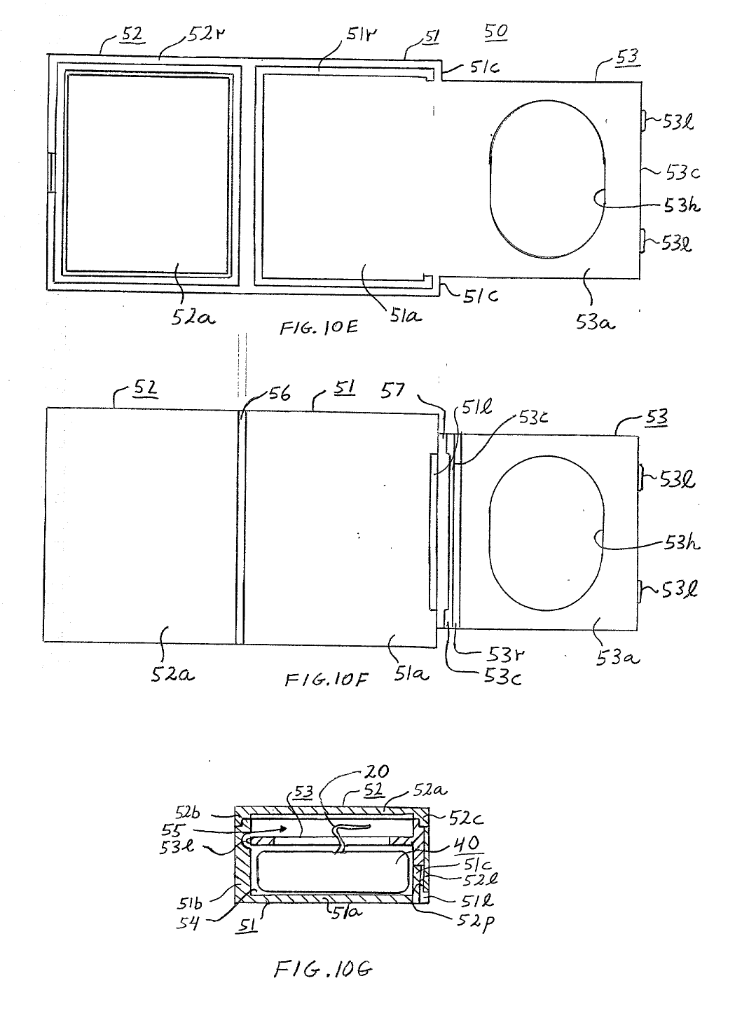

FIG. 1 shows a side view of a conventional roll of poly bags. FIG. 2 shows a top view of the conventional poly bags of FIG. 1. Referring to the Figs., numeral 11 designates a roll of poly bags supported on a shaft 12 passing through the center thereof. Numeral 20 designates a plurality of poly bags which are joint to each other. The poly bags 20 each have one end thereof 20c which is heat treated to close the respective bags and a perforation line 20p which allows for the easy tearing of each bag from the one adjacent to it, which not only allows the bags to be separated from each other but also provides each bag with an open end through which various items can be inserted. These types of bags are very common and can be found in Supermarkets for shoppers to store things they want to buy, such as tomatoes, etc. Numeral J-K designate lines and dashes which represent folding lines where the bags 20 are folded, so that the width of the poly bags is reduced to 1/3 its original width. (An automated way of doing this is describe with reference to FIG. 9 for the films 17 and 18 using a folding guide blade 32 in the form of an inverted triangle of U.S. Pat. No. 4,744,673).

FIG. 3 shows a top view of the poly bags of FIG. 2 after being folded twice along lines J-K, namely along the length of the joint poly bags 20. Referring to the Fig., it can be seen that the amount of space in the width direction of the each bag 20 is only one third the actual width thereof, since each bag is folded twice in its width direction.

FIG. 4 shows a cross sectional view at line I-I of FIG. 3. Referring to the Fig., each poly bag 20 comprises a top and a bottom film 1f, 2f which have been folded along the width thereof at lines J and K. FIG. 5 shows the same view as FIG. 4 but showing the poly bag in line form to simplify the drawing thereof.

FIG. 6 shows a side view of the folded poly bags 20 of FIG. 3 further being folded sequentially up and down (as designated by symbols U and D, respectively) along the length of the poly bags. Referring to the Fig., it can be seen that each poly bag is folded up and down at fixed interval in an accordion fashion, which results in a very compact poly bag requiring a relatively small surface area.

FIG. 7 shows a perspective view of the vinyl bags of FIG. 2 in a three-dimensional Cartesian mathematical representation system for facilitating the explanation of the folding steps of the vinyl bags. Referring to the Fig., the plurality of poly bags 20 are shown in the x-z plane with the width of the poly bags 20 along the x coordinate and the length of the bags 20 along the z coordinate. Accordingly, the folds J-K are lines running along the z coordinate and hereinafter will be referred to as “folds along the width of the poly bag 20”. Furthermore, folding the poly bags 20 along the length thereof represents lines running in parallel to the perforated lines 20p which are along the x coordinate and hereafter will be referred to as “folds along the length of the poly bag 20”.

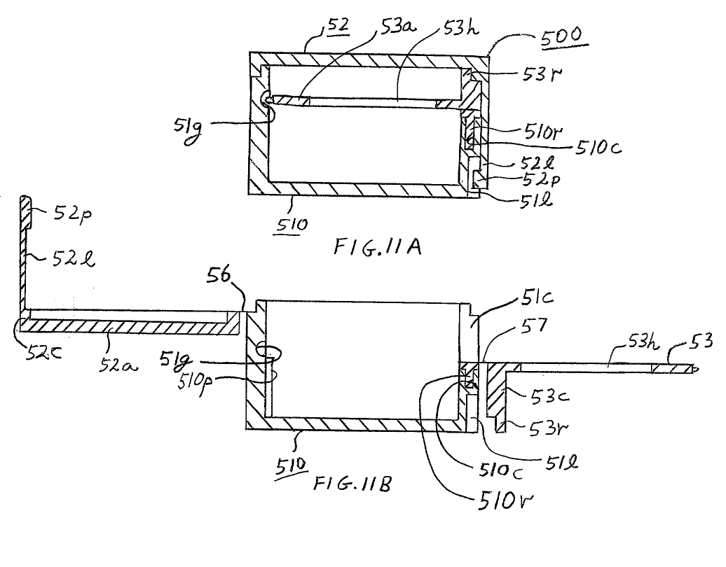

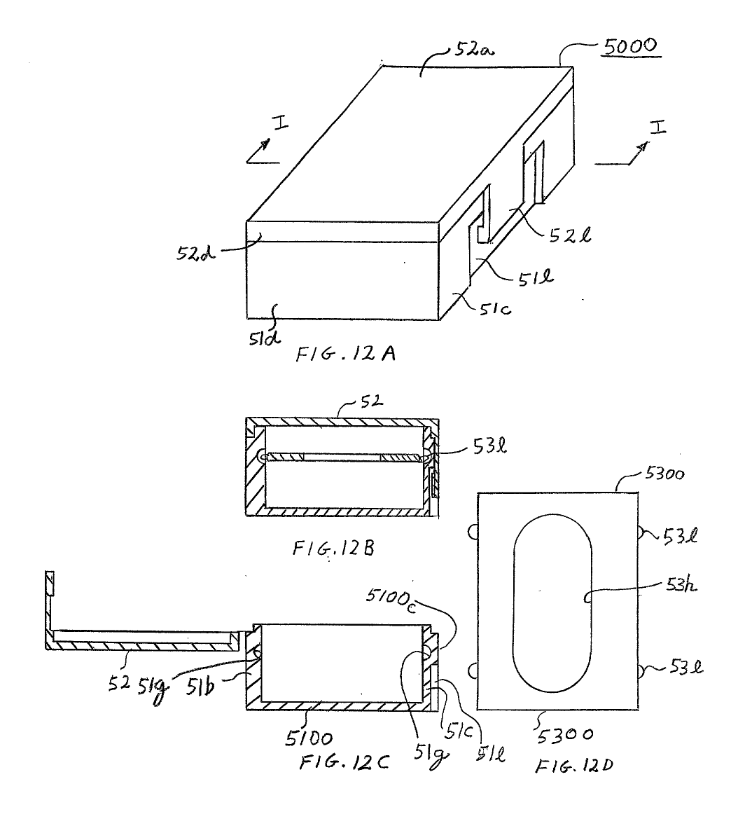

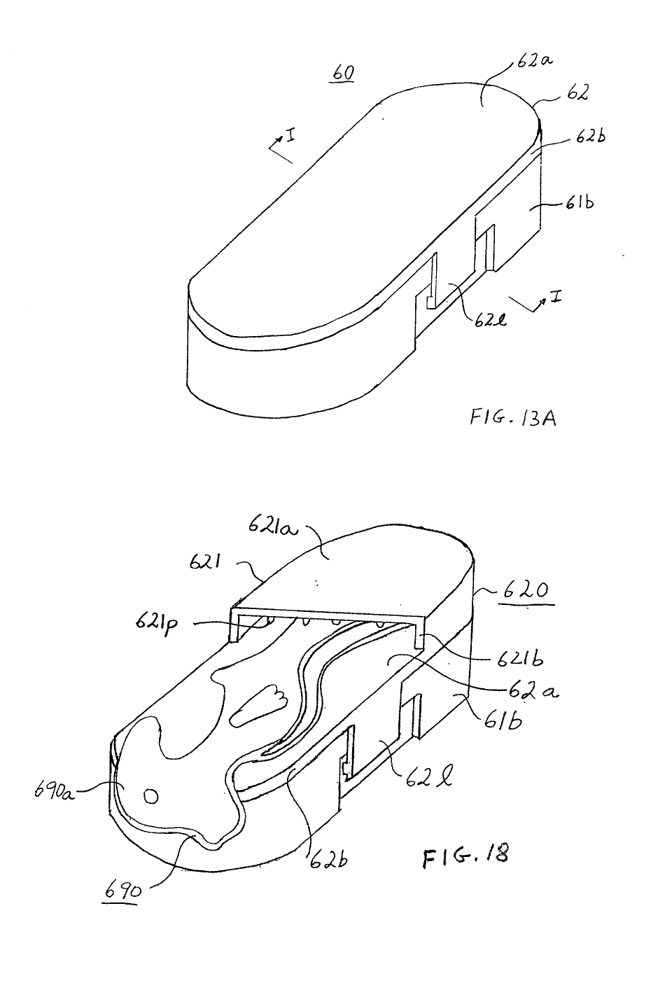

FIGS. 8A-8C show a perspective view an end view and a front view of the vinyl bags 20 of FIG. 2 after being folded as shown in FIG. 5 and FIG. 6 and then wrapped and sealed inside a vinyl cover 30 to form a poly bag pack 40 according to the present invention. Referring to the Figs., the above described folded poly bags 20 are wrapped by a thin film of vinyl 30 (hereinafter referred to as “cover 30”) such that the two ends 30a and 30b of the cover overlap each other. The two sides 30s of the cover are then subjected to a heat-sealing machine (not shown), which is well known in the art to seal the two sides to form a poly bag pack 40. The combination of the folded poly bags 20 stored inside the cover 30 will be referred to as “poly bag pack” 40 or simply “the pack” 40 hereinafter. Accordingly, the folded poly bags 20 can be pulled out of the pack 40 one by one (i.e. one after the other) by simply pulling the top poly bag 20 in the pack 40 through the slot 30c present between the two ends 30a and 30b of cover 30. As each bag 20 is pulled out of the pack 40, it can be torn from the other poly bags 20 inside the pack 40 by simply pulling along the two sides of the perforated lines 20p. As shown in FIG. 8C, the width of the cover 30 should be made wide enough to allow at least 20 and preferably 30 folded poly bags to fit inside the cover 30 and still be sufficiently wide to allow the sides of the cover 30 to be sealed using a convention heat sealing machine (not shown) without interfering with the folded poly bags 20 inside.

For a persons hand to fit comfortably inside a bag 20, the bags preferably are 24 cm. wide, 30 cm. long and 0.03 milimeters thick. By folding each bag 20 two times along the width thereof and five times along the length thereof, results in the each bag being 8 cm wide, 5 cm. long and 0.54 milimeters thick. Accordingly, a pack of 30 bags would be 8 cm. wide, 5 cm. long and 1.62 cm high. This size of pack of poly bags is very convenient to carry around in a coat pocket or pants pocket. Further, by packing the poly bags 20 inside the cover 30 with the open end of the first bag 20 facing the slot 30c, each bag pulled out of the cover 30 will have its open end come out first, facilitating for the easy and quick use thereof. Further, since the slot 30c in the cover 30 is facing the width side of the poly bags stored therein, which is now longer than the length side thereof, due to the way the poly bags are folded, not only does the open end come out first from the slot 30c in the cover 30, but also, since each bag 20 is being automatically unfolded along the length of the poly bag 20 as it is pulled out of the slot 30c in the cover 30, each poly bag need be unfolded only twice before being able to use the bag for storage. This greatly facilitates for not only the compact and convenient storing of the poly bags 20, but also the quick and easy use of the poly bags. Once a poly bag is pulled out of the cover 30, the user need only rip the bag 20 apart from the one adjacent to it at the perforated line 20p, whereby the next bag 20 is ready to be pulled out the next time the user needs one. Moreover, the bags 20 can easily be separated at the perforated lines 20p, even though they come out of the cover 30 partially folded, i.e., twice along the width thereof, when the bags 20 are pulled out of the cover 30, because they only remain folded along the width thereof, whereby the perforated lines are “layered” on top of each other in a straight line, thereby allowing for the tearing of the bags 20 extending out of the cover 30 evenly and easily.

It should be noted that the last three or four bags to come out of the pack 40 can have stripes printed on them to distingquish them from the rest to the bags 20 in the pack 40, so that the user of the pack 40 can be notified that he or she is running out of bags 20 and should bring an extra pack 40 the next time they take their dog for a walk.

FIGS. 9A-9H show a front view of a vinyl bag 10 being folded twice along the length thereof and 5 times along the width thereof. FIGS. 9I-9K show an end view of the bag 10 of FIGS. 9A-9C, respectively in line form. FIG. 9L shows an end view of the bags 10 being folded 5 times up and down along the along the length thereof. FIG. 9M shows a side view in line form of three poly bags 10 in line form which have been folded twice along the width thereof and then five times along the length thereof, each bag 10 having a part thereof folded inside the bag 10 adjacent to it. FIG. 9N shows a side view in line of three pulley bags 10 in line form which have been folded twice along the width thereof and then four times along the length thereof, each bag 10 having a part thereof folded inside the bag 10 adjacent to it. FIG. 9O shows a front view of a sheet of vinyl 9 for wrapping the plurality of vinyl bags shown in FIG. 9M or 9N to form a packet of vinyl bags according to the present invention. FIG. 9P shows a side view of the vinyl sheet 9 of FIG. 9O. FIG. 9Q shows the sheet of vinyl 9 of FIG. 9O after being wrapped around the plurality of vinyl bags of FIG. 9M or 9N to form a packet of vinyl bags 400 according to the present invention. Referring to FIGS. 9A-9C, numeral 10 designates a conventional poly bag having a closed end 10b at one end thereof and an open end 10a along the other end thereof. The poly bag 10 is first folded twice along the width direction thereof at the dash lines designated by symbols A, B (i.e. as shown from the side view 9I-9K). Next, as shown in FIGS. 9D-9H, the poly bag 10 is folded five times along the length direction thereof at dash lines designated by symbols C,D,E,F,G, thereby providing a bag 10 having a very small surface area when compared to the actual size of the poly bag 10. Alternatively, the bag 10 may be folded along the length thereof as shown in FIG. 9L, which results in the same thing. Next, as shown in FIG. 9M, the thus folded poly bags 10 are stacked on top of each other with the portion of the last fold G having the open end 10b of one bag 10 tucked into the folded portion E having the closed end 10b of the adjacent bag 10, so that when one thus folded poly bag 10 is pulled out of a cover 9, the open portion 10b of the adjacent poly bag 10 is consequently also partially pulled out of the cover 9, thereby facilitating for the easy withdrawal of a bag 10 the next time the user needs a bag 10. In FIG. 9N, the bag 10 has been folded twice along the width thereof and four times along the length thereof.

After the bags 10 are folded as illustrated in FIGS. 9A-9L, and then stacked on top of each other with the closed and open portions of each bag 10 tucked into the open and closed ends of the adjacent poly bag 10, respectively, as shown in FIGS. 9M and 9N, the bags thus folded, stacked on and tucked into each other are than wrapped inside a thin film 9 as shown in FIG. 9Q. Then the two sides 9s of the film 9 are heat sealed using conventional heat sealing machines (not shown) to form a poly bag pack 400. Preferably, the pack 400 has at least 20 folded poly bags and preferably 30 folded poly bags stacked inside the pack 400, so that the user can have a month supply of poly bags for his or her dog.

It should be noted that the number of folds along the width of the bag 10 could be reduced to one instead of two and the number of folds along the length of the poly bag 10 can also be reduced to two instead of four or five and that the bags thus folded can still be stacked and tucked into each other similar to the way shown in FIG. 9M.

It should be further noted that the color of the last three or four poly bags to come out of the pack 400 could have a different color than the rest of the bags in the pack 400, whereby the user is visually informed of the fact that only a few bags remain in the pack, and should bring along one more full pack 400 the next time he or she walks their dog.

FIG. 10A shows a perspective view of a storage-dispensing device 50 for housing a pack of poly bags 40 therein and for sequentially dispensing the poly bags 20 stored in the pack 40, the device being in a closed position. FIG. 10B shows a cross sectional view at line I-I of FIG. 10A of the storage-dispensing device, the device being in a closed position. FIG. 10C shows a cross sectional view at line I-I of FIG. 10A of the storage-dispensing device, the device having the cover portion thereof in the open position. FIG. 10D shows a cross sectional view at line I-I of FIG. 10A of the storage-dispensing device, with the cover and divider portions thereof in the open position. FIG. 10E shows a top view of the storage-dispensing device with the cover and divider portions thereof in the open position. FIG. 10F shows a bottom view of the storage-dispensing device 50 with the cover and divider portions thereof in the open position.

Referring to FIGS. 10A-F, numeral 50 generally designates a storage-dispensing device for storing the poly bag pack 40 in one compartment 54 thereof and for dispensing the poly bags 20 in the pack 40 through another compartment 55 thereof according to the present invention. The storage device 50 comprises a first container portion 51, having the shape of a rectangular container, for storing the poly bag pack 40 in, a second cover portion 52, having the shape of a rectangular cover, for closing the open side of the first portion 51 and a divider portion 53 for separating the container portion 51 and the cover portion 52 into two compartments 54, 55 and allowing for the dispensing of poly bags therethrough.

The container portion 51 comprises a rectangular shaped flat bottom section 51a, a first long side walls 51b, a second long side wall 51c and two short side walls 51d and 51e, said side walls 51a-d being integrally formed with the outer periphery of the bottom section 51a along the bottom edges thereof and together define the shape of a rectangular container. The container portion 51 further comprises a female latch section 51l, namely, the wall 51c has a square groove 51l formed along the bottom middle section thereof for receiving a male latch portion 52l of the cover portion 52 therein.

The cover portion 52 comprises a rectangular shaped flat section 52a, a first long side wall 52b, a second long side wall 52c, and two short side walls 52d and 52e, said side walls 52a-d being integrally formed with the outer periphery of the top section 52a along the top edges thereof and together define the shape of a rectangular cover. Numeral 52l designates a male latch section, which comprises a square protrusion integrally formed along a central bottom edge of the long side wall 52c. The male latch section 52l has a round shaped protrusion 52p integrally formed therewith along the extending inner side thereof. Accordingly, when the cover portion 52 is in the closed position, the protrusion 52p of the male latch section 52l latches onto the inside of the female latch portion 51l, to close the device 50.

Numerals 51r and 52r designate ridges formed on the extending edges of the walls 51b-51e and 52b-52e, respectively, of the container portion 51 and the cover portion 52. When the device 50 is in a closes position (i.e. as shown in FIGS. 10A, 10B), the ridges 51r and 52r line up against each other, thereby making the device water proof, so that rain water will not get in when the user is walking his or her dog outdoors.

The divider portion 53 comprises a rectangular flat section 53a having an elliptically shaped hole 53h formed through the center thereof. Numeral 53c designates a wall formed along the top side of the flat section 53a having a ridge formed along the extending edge of the wall 53c. The wall 51c and the wall 53c have the same profile and are in line with each other when the divider 53 is in the closed position (i.e. as shown in FIG. 10C). Numeral 53l designate a pair of male latch portions in the form of two round protrusions formed along the extending long side 53c of the flat portion 53a which fit into corresponding grooves 51g formed along the inner side of the long wall section 51b of the container portion 51.

The device 50 is made of plastic such as polypropiline or nylon using conventional injection molding techniques.

Numeral 56 designates a flexible thin strip of plastic (hereinafter referred to as a hinge 56) the respective sides of which are integrally formed along the respective extending edges of the long walls 51b and 52b, thereby, not only joining the cover portion 52 to the container portion 51, but also providing a hinge function for allowing the cover portion 52 to pivot from a closed position to an open position with respect to the container portion 53.

Numeral 57 designates a flexible thin strip of plastic (hereinafter referred to as hinge 57) the respective sides of which are integrally formed along the respective extending edges of the long walls 51c and 53c, thereby, not only joining the divider portion 53 to the container portion 51, but also providing a hinge function of allowing the divider portion 53 to pivot from a closed position (i.e. as shown in FIGS. 10B 10C) to an open position (i.e. as shown in FIG. 10D. The hinges 56, 57 are well known in the art of plastic injection molding techniques and are extensively used in plastic boxes.

FIG. 10G shows a cross sectional view at line I-I of FIG. 10A of the storage-dispensing device, the device being in a closed position and having a pack of poly bags 40 stored therein according to the present invention. Referring to the Fig., the pack 40 is stored inside the compartment 54 and has the next available poly bag 20 partially extending through the hole 53h formed in the divider portion 53 into the compartment 55. Accordingly, in order to pull out a vinyl bag out of the pack 40, the cover portion 52 is opened and then the portion of the vinyl bag 20 extending into the compartment 55 is manually pulled out of the device, thereby causing the next available poly bag in the pack 40 to extend through the through hole 53h in the the divider portion 53 into the compartment 55. Accordingly, the divider portion serves two functions, namely, not only allows the poly bags 20 stored in the pack 40 to pass through the central hole 53h formed through the center thereof, but also stops the pack 40 from being pulled out of the compartment 54 and out of the device 50 while a poly bag 20 is being pulled out therefrom.

FIGS. 11A-11B show side cross sectional views of a poly bag storage dispensing device 500 according to another embodiment of the present invention, with the cover 52 and divider 53 portions thereof in the closed and open position, respectively. The poly bag pack storage dispensing device 500 is substantially the same as the device 50 and only the differences therebetween will be described herebelow. In the Figs., the same or corresponding parts will be designated the same numeral numbers.

Referring to FIGS. 11A-11B, it can be seen that the only difference between the device 50 and the device 500 is that the divider portion 53 is not integrally formed with the container portion 510. Namely, the container portion 510 is the same as the container portion 50, but instead of being integrally formed with the divider portion 53, the container portion 510 has a rectangular cavity formed along the wall 51c for frictionally receiving an extending end of a ridge 510r therein. The other end of the ridge 510r is integrally formed with one side of the hinge 57. Numeral 510p designates a pillar integrally formed along the inner surface of the container 510. The pillar extends to just below the groove 51g and acts as a barrier for preventing the divider portion 53 from being pushed into the container 510 further than the groove 51g. In all other aspects, the device 500 is the same as the device 50.

FIG. 12A shows a perspective view of a poly bag pack storage dispensing device 5000 according to another embodiment of the present invention. FIG. 12B shows a cross sectional view at line I-I of FIG. 12A with the cover portion 52 in the closed position and the divider portion thereof inserted. FIG. 12C shows an end cross sectional view at line I-I of FIG. 12A with the cover portion 52 thereof in the open position and the divider portion thereof removed. FIG. 12D shows a top view of the divider portion 5300 according to the present invention.

Referring to FIGS. 12A-12D it can be seen that the device 5000 is very similar to the device 50 with the only exception being that a divider portion 5300 is not an integral part of the of a container portion 5100. The molds for the injection molding process for manufacturing the device 5000 are simpler than the molds for manufacturing the device 50, and accordingly, the tooling operation for manufacturing the molds therefor are cheaper. However, the disadvantage of the device 5000 is that, although initially some tooling costs are saved, the device 5000 comprises two separate parts. Only the portions of the device 5000 which are different from those of the device 50 will be described herebelow. In the drawings, the same or equivalent portions will be designated by the same numerals or symbols. As can be seen from best from FIG. 12D, the divider portion 5300 has four protrusions 53l which lock inside four correspondingly formed grooves 51g formed along the inner side walls 51b, 51c of the container portion 5100. The wall 51c is formed to have the same structure as the wall 51b, except for the wall 51c also having the groove 51l formed along the outer surface thereof. Accordingly, the divider 5300 is mounted inside the container 5300 by simply manually pushing it into the inside of the container 5300 until the protrusions 53l lock inside the grooves 51g.

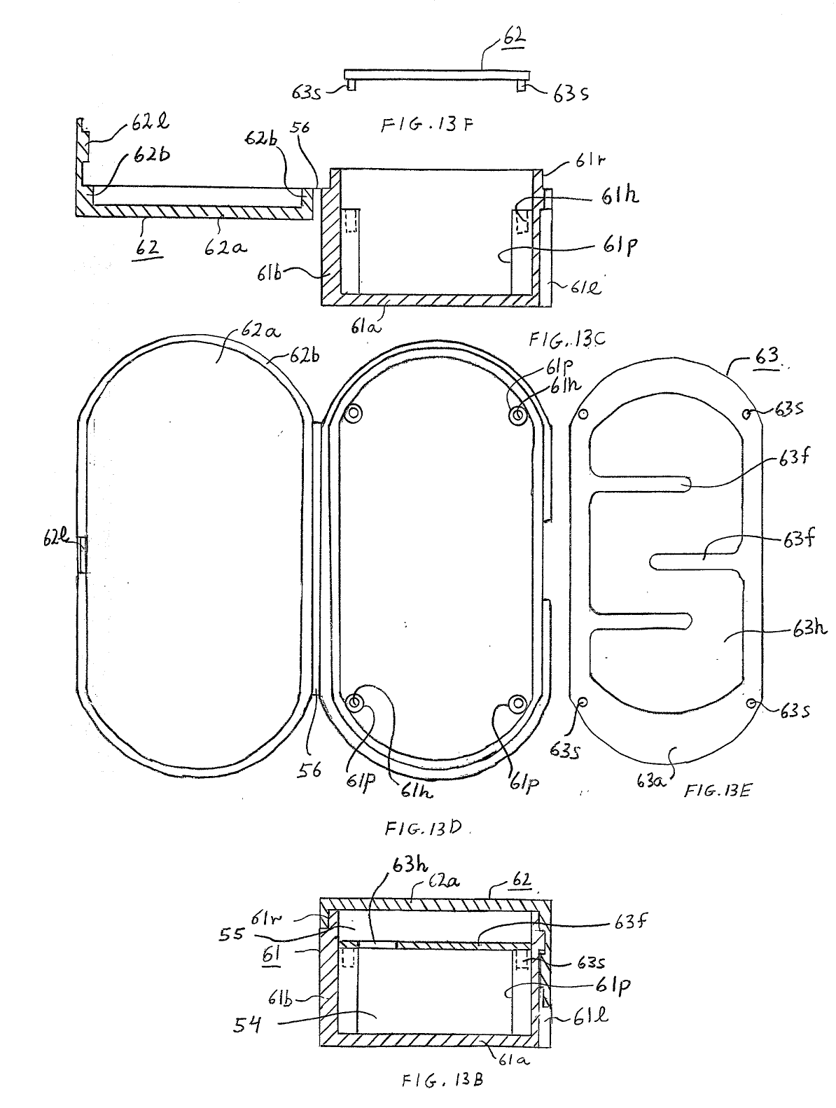

FIG. 13A shows a perspective view of a poly bag pack storage dispensing device 60 according to another embodiment of the present invention. FIG. 13B shows a side cross sectional view at line I-I of the device 60 of FIG. 13A in a closed position and with a divider portion 63 mounted therein. FIG. 13C shows a side cross sectional view at line I-I of the device 60 of FIG. 13A in an open position and with a divider portion 63 removed. FIG. 13D shows a top view of the device 60 in the open position and with the divider portion 63 removed. FIGS. 13E and 13F show a top view and an end view of the divider 63 according to the present invention. Referring to the Figs, the device 60 comprises an elliptically shaped container portion 61, an elliptically shaped cover portion 62 and an elliptically shaped flat divider portion 63. The elliptical container portion 61 comprises an elliptically shaped bottom section 61a and an elliptically shaped wall section 61b having a ridge 61r formed along the extending end thereof. The wall section 61b has a square groove 61l (female latch section) formed along the outer side thereof for receiving a male latch section 62l therein. The container portion 61 further has four pillars 61p formed along the inner walls thereof at fixed intervals, the pillars 61p extending from the bottom section 61a to a point below the ridge section 61r, each pillar 61p having a central hole 61h partially formed therethrough. The bottom section 61a and the wall section 61b are integrally formed with each other. The elliptical cover portion comprises an elliptically shaped top section 62a and an elliptically shaped wall section 62b having a square protrusion 62l (i.e. male latching portion 62l) formed along an extending edge thereof. The top section 62a, wall section 62b and the male latching portion 62l are integrally formed with each other. Numeral 56 designates a flexible hingeone side of which is integrally formed with an extending end of the wall section 62b and the other side of which is integrally formed with an extending end of the wall 61b, whereby the cover portion 62 can be swung from an open position to a closed position with respect to the container portion 61. When the device 60 is in a closed position, the walls 62b and the ridge 61r are adjacent to each other and the male latching section 62l is locked in the female latching section 61l. The elliptically shaped flat divider portion 63 comprises a flat plate 63a having an elliptically shaped hole 63h formed through the central portion thereof and three finger like protrusions 63f integrally formed therewith along the inner walls thereof at fixed intervals therebetween, said protrusions 63f extending towards the center of the divider portion 63 and said finger like protrusions 63f being flexible due to the thinness thereof and due to the material used in the manufacture of the divider portion 63 (i.e. plastic or nylon). Accordingly, the finger like protrusions 63f serve to prevent a portion of a poly bag extending therethrough from falling back into the poly bag pack storage compartment 54. The divider portion 63 further comprises four round shafts 63s formed along one side of the flat plate 63a. The outer circumference of the divider portion 63 is equal to the inner circumference of the inner side of the wall 61b of the container portion 61, so that the divider 63 can fit inside the container 61 (the divider portion should be made square instead of oval in this case). Furthermore, when the divider portion 63 is inserted into the container portion 61, the shafts 63s of the divider 63 frictionally fit into respective holes 61h formed in the extending ends of the pillars 61p, whereby the divider portion 63 is fixed inside the container 61, thereby creating the two compartments 54, 55 for respectively storing the poly bag pack and for storing the extending end of the poly bag to next be pulled out of the device 60. Accordingly, to insert a poly bag pack inside the compartment 54, the divider 63 is manually removed (i.e. by pulling on it till the shafts 63s come out of the holes 63s), and then the pack of poly bags 40 is inserted inside the container 61a with the open side 30a of the cover 30 facing up. Then, the divider 63 is re-inserted into the container 61 with the shafts 63s forced into the holes 61h. Then a poly bag 20 is manually pulled out of the container via the flexible finger portions 63f until the next bag partially extends through the divider portion 63, whereby, the finger portions 63f crumple the bag passing therethrough to prevent the poly bag from falling back into the container 61. This is especially useful when the number of poly bags 20 left in the poly bag pack 40 decreases, since the space inside the compartment 54 becomes relatively empty, allowing for the extending end of a poly bag passing through the divider 63 to fall back into the compartment 55.

It should be noted that the oval shape of the device 60 can be applied to all the other devices described above. Further that the hinge 57 could have been used with the device 60 similar to the way the hinge 57 was used with the device 50 by modifying part of the wall 61b to have a similar profile to the wall 51b.

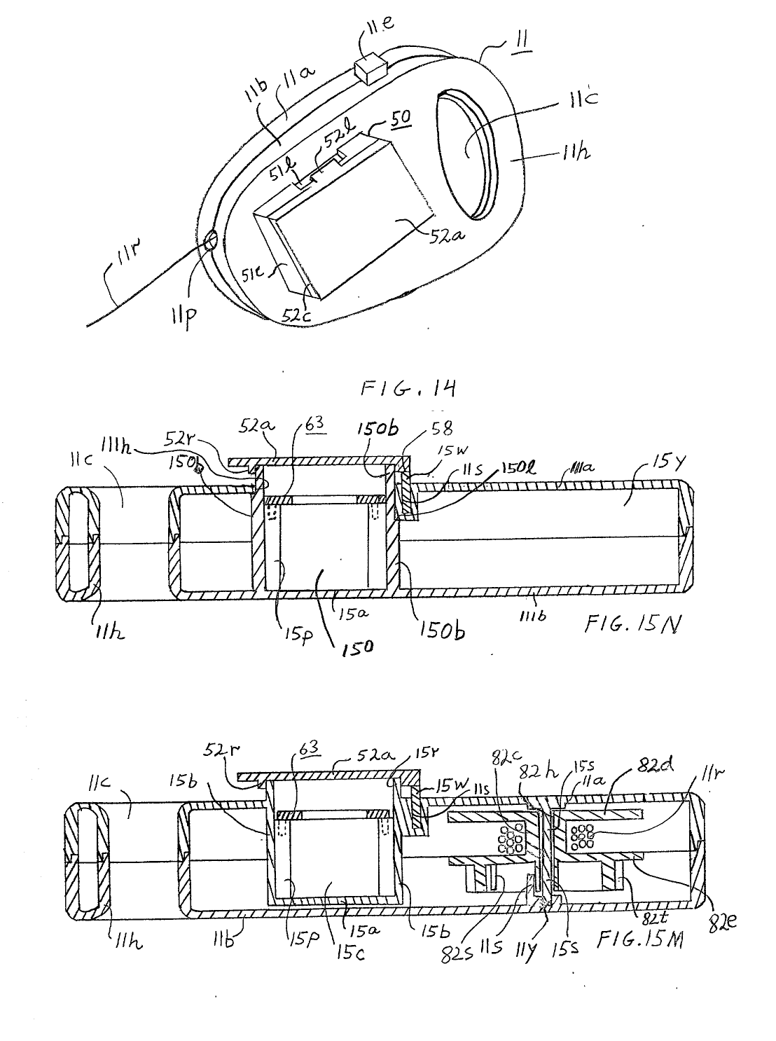

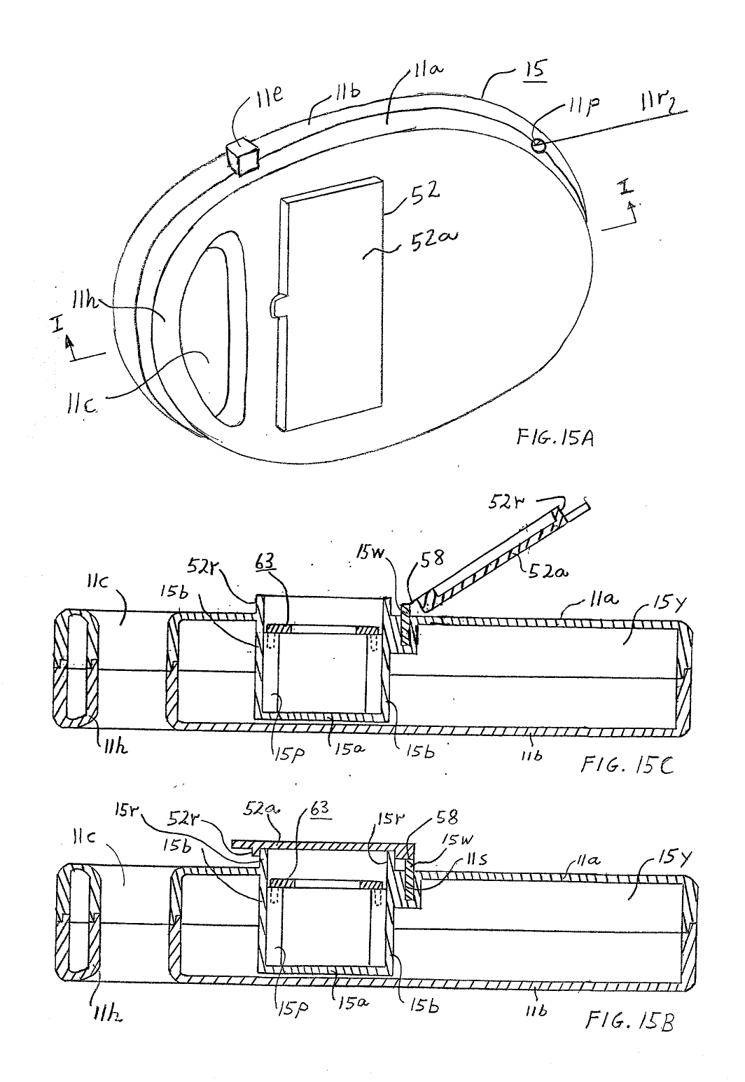

FIG. 14 shows a perspective view of the poly-bag-pack-storage-dispensing device 50 of the present invention mounted on one side of a conventional dog leash storage-extension apparatus 11. The dog leash storage apparatus 11 is commonly available on the market and it basically comprises a plastic case made of an upper and lower plastic case portions 11a, 11b which fit against each other and form a case having a cavity therebetween for storing a rope 11r therein, the rope 11r being extendable and retractable through a hole 11p formed in the case portions 11a, 11b by the manual activation of a push button le. The case portions 11a and 11b are connected to each other by conventional screws (not shown). Inside the case, there is also mounted a spring loaded round pulley (not shown) for retracting and storing the rope 11r thereon when the button is activated. This apparatus is well known in the art and many variations thereof are available on the market. The dog leash storage-extension apparatus 11 further comprises a handle portion 11h for holding on to, the handle being defined by an opening 11c formed in the case. The poly-bag-pack-storage-dispensing apparatus 50 of the present invention is mounted on the outer surface of the upper case portion 11a of the dog leash storage-extension apparatus 11 using a conventional strip of tape (not shown) which has a sticky surface on both sides thereof. These tapes are commonly available. A strip of tape can be stored inside of the poly-bag-pack-storage-dispensing device 50 during the marketing thereof. Accordingly, when a person wants to attach the poly-bag-pack-storage-dispensing device 50 to the outside surface of the dog leash storage-extension apparatus 11, he or she simply can remove the paper protective covering from both sides of the strip of tape (not shown) and apply one side of the strip of tape to one side of the dog leash storage-extension apparatus 11, as shown in FIG. 14, and then press the outer surface of the rectangular bottom section 51a of the container portion 51 against the other side of the strip. Accordingly, with the poly-bag-pack-storage-dispensing device 50 permanently mounted on the side of the dog leash storage-extension apparatus 11, the dog owner need never worry about forgetting to bring a poly bag along whenever he or she walks their dog.

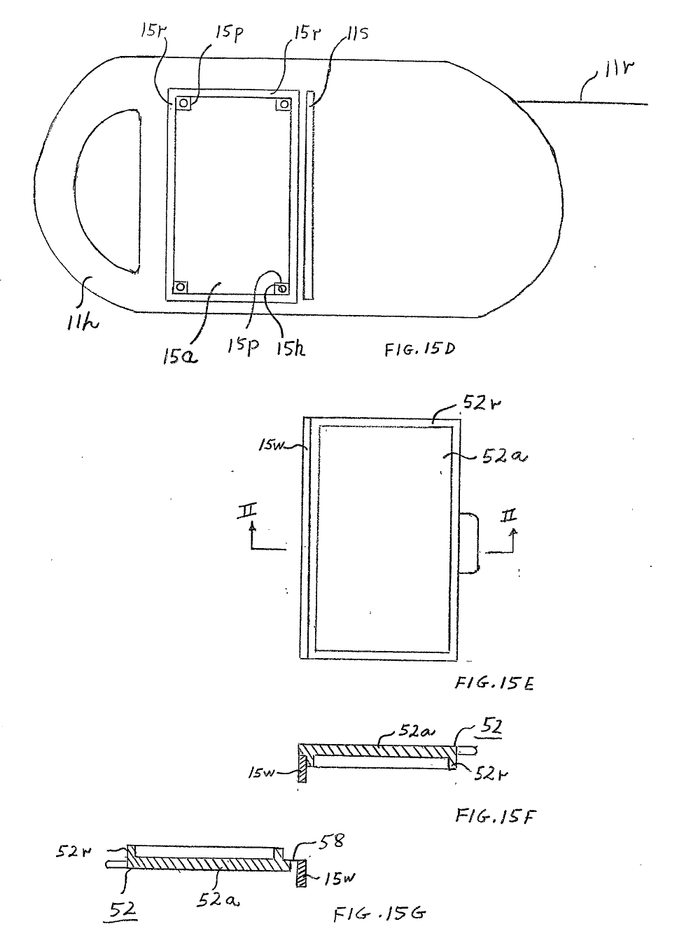

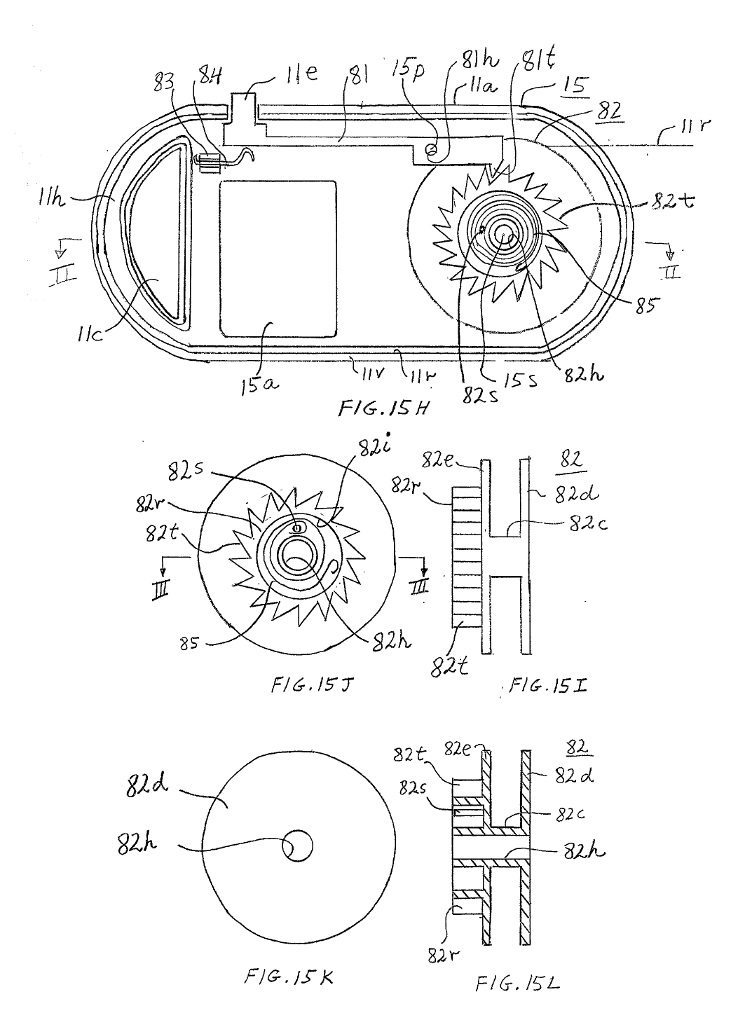

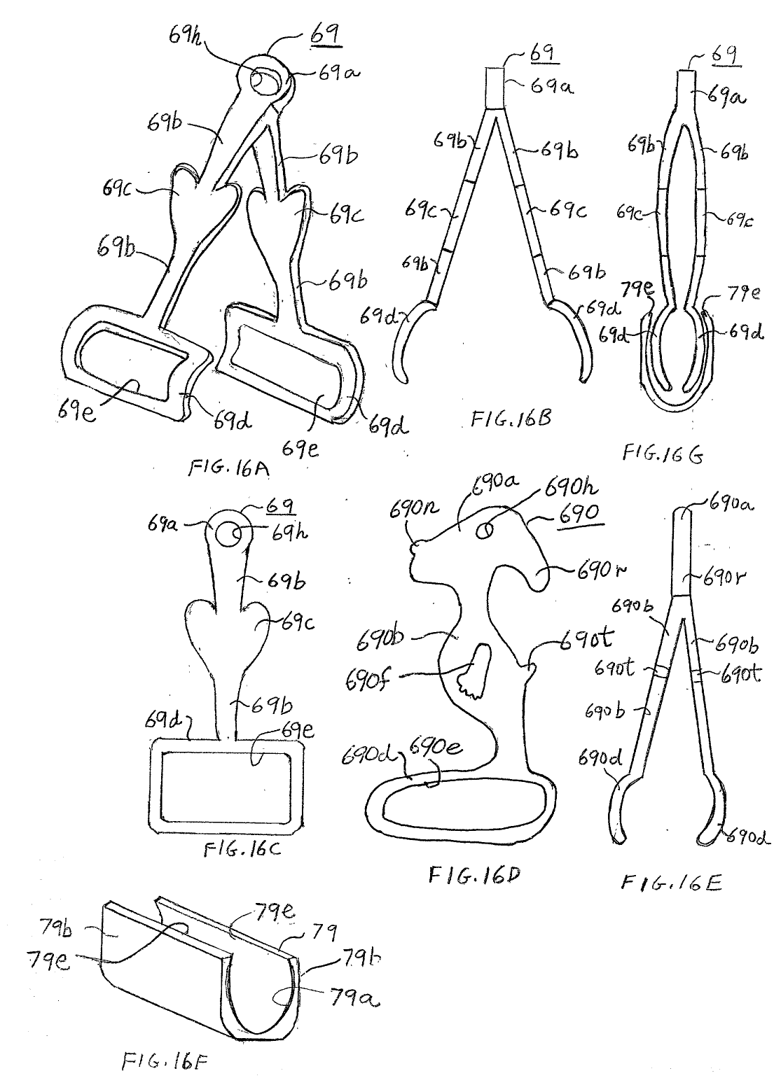

FIG. 15A shows a perspective view of a dog leash storage extension apparatus 15 having the poly bag pack storage dispensing device integrally formed therewith according to the present invention. FIG. 15B shows a side cross sectional view of the apparatus at line I-I of FIG. 15A with the cover section 52 thereof in the closed position. FIG. 15C shows a side cross sectional view of the apparatus at line I-I of FIG. 15A with the cover section 52 thereof in the open position. FIG. 15d shows a front view of the dog leash storage extension apparatus 15 without the cover section 52 mounted thereon. FIG. 15E shows a bottom view of the cover section 52. FIGS. 15F and 15G show side cross sectional views of the cover portion only at line I-I of FIG. 15A, the covers portion being in the closed and open positions, respectively. Referring to the Figs, the dog leash storage extension apparatus 15 is substantially the same as the conventional dog leash storage extension apparatus shown in FIG. 14, with the only difference being that instead of mounting the poly bag pack storage dispensing device 50 on the outside surface of the dog leash storage extension apparatus 15, the poly bag pack storage dispensing device 50 is integrally formed with the dog leash storage extension apparatus 15. In the drawings, the same numerals and symbols will be used to designate the same or similar parts. Referring to the Figs., the upper case portion 11a has been modified to further include a rectangular cavity (i.e. a compartment which serves the same purpose as the container portion described above) 15c formed by four side walls 15b integrally formed with the upper case portion 11a and a flat bottom section 15a integrally formed at the inner edges of the side walls 15b. The walls 15b extend from the outer surface of the upper case portion 11a to substantially the inside surface of the lower case portion 11b. Numeral 52r designates a ridge formed around the periphery of the opening of the rectangular cavity along the outer surface of the upper case portion 11a. Numeral 15p designate four pillars each having a round hole 15h formed through the center of the extending end thereof. The pillars 15p are similar to the pillars 61p and are used for mounting the divider portion 63 thereon, similar to the way the divider 63 is mounted in the device 61. The cover portion 52 comprises a rectangular flat section 52a, a rectangular ridge section 52r integrally formed on one side of the flat section 52a. When the cover 52 is in the closed position, the inner sides of the ridge 52r but up against the outer sides of the ridge 15r on the cover 11a, whereby the rectangular cavity 15a is made waterproof. Numeral 15w designates a rectangular wedge section which is frictionally mounted inside a rectangular slot 11s formed in the cover 11a. Numeral 58 designates a hinge one side of which is integrally formed with one side of the rectangular flat section 52a and the other side of which is integrally formed with one end of the rectangular wedge 15w, whereby the cover 52 can swivel with respect to the wedge section 52w, thereby to open and close the rectangular cavity 15c. Numeral 63 designates the divider 63 shown in FIGS. 13B, 13E, 13F and is mounted on four pillars 15p the same way as the divider 63 is mounted on the pillars 61p of the device 60. The space 15y inside the upper case portion 11a 11b is used for housing the rope 11r extension retraction mechanism (not shown) which is well known in the art. Accordingly, by simply modifying the shape of the upper case portion 11a and by adding two parts, namely, the cover portion 52 and divider portion 63, a poly bag pack storage disposal device is realized in a dog leash storage-extension apparatus 11. Moreover, by utilizing some of the empty space inside the dog leash storage-extension apparatus 11, at a very small increase in cost, a poly bag pack storage disposal device is incorporated, thereby greatly enhancing the usefulness of the dog leash storage-extension apparatus 11.

FIG. 15N shows a cross sectional view at line I-I of a dog leash storage extension apparatus 150 having the poly bag pack storage dispensing device integrally formed therewith according to another embodiment of the present invention. Only the portions which are different from the apparatus shown in FIG. 15B will be described hereinafter. Referring to the Fig., numeral 150 designates a rectangular container integrally formed along the inner surface of the case portion 111b. The container 150 is defined by the a portion of the inner surface of the case portion 111b and side walls 150b which together form a rectangular container 150. The case portion 111b is the same as the lower case portion 11b in all other aspects. Numeral 111a designates a case portion which is the same as the upper case portion 11a except for having a square through hole 111h formed therein for allowing the side walls 150b of the container 150 to frictionally pass therethrough (i.e. the walls of the container 150 just fit inside the rectangular hole 111h). The walls 150b are formed to be slightly thinner beyond the point where the inner wall of the case portion 111a is positioned, whereby a lip 150p is created for the periphery of the case around the hole 111h to butt up against, thereby creating a stronger apparatus as well as making it more water proof. The cover 52 is exactly the same and serves to cover the extending ends of the walls 150b. According to this embodiment the container 150 can be made deeper than the container 15 of FIG. 15C, since the wall 15a is not necessary with this embodiment and the inner wall of the case portion 111b serves as the bottom of the container 150. This will further reduce the weight and price of the apparatus while increase the usefulness thereof.

FIG. 15H shows an inside view of a dog leash storage extension apparatus 15 having the poly bag pack storage dispensing device integrally formed therewith as well as a particular structure for the dog leash extension/retraction apparatus according to the present invention. FIG. 15I shows an end view of a pulley 82 used in the dog leash extension/retraction apparatus shown in FIG. 15H. FIG. 15J shows a front view of the pulley 82 having a wind up spring 85 mounted therein. FIG. 15K shows a back view of the pulley 82. FIG. 15L shows a cross sectional view at line III-III of FIG. 15J of the pulley 82, without the wind up spring 85 mounted therein. FIG. 15M shows a cross sectional view at line II-II of FIG. 15H. Referring to the Figs., the plastic upper case portion 11a comprises all the portions described above with reference to FIGS. 15A-15D, and further comprises the portions described hereafter which realizes one embodiment for the dog leash extension/retraction apparatus according to the present invention. Numeral 15s designates a round first shaft formed along a central inner part of the upper case portion 11a for supporting a pulley 82 thereon. The lower case portion 11b has a round recess 11y for frictionally receiving the extending end of the first shaft 82s therein. Numerals 11r and 11v designate a ridge and a valley, respectively, which fit into a respective valley and ridge formed in the lower case portion 11b, to make the case 15 water resistant. Numeral 15p designates a round second shaft formed on the inside surface of the upper case portion 11a for supporting an arm portion 81 thereon. The arm portion 81 is integrally formed on a bottom surface of the push button 11e, and has a through hole 81h formed along a central portion thereof for allowing the shaft 15p to slidingly fit therein. Numeral 81t designates a tooth like wedge formed on the extending end of the arm portion 81. Numeral 84 designates a leaf spring one end of which is mounted in a slot formed in a protrusion 83 which is formed on the inner surface of the upper case portion 11a and the other end of which pushes against the bottom surface of the push button 11e, so as to keep the push button 11e in an upward position. Numeral 82 designates a round pulley which comprises a cylindrical portion 82c having a through hole 82h formed through the center thereof for receiving the first shaft 15s slidingly therein. Numerals 82d, 82e designate two round discs formed on the outer surface of the cylindrical portion 82c at respective ends thereof. The space between the two discs 82d and 82e is utilized for housing a rope 11r which is wound or unwound on the cylindrical portion 82c when the pulley 82 is turned clock wise or counter clock wise, respectively. Numeral 82r designates a protrusion formed on the outer surface of the round disc 82e, the protrusion 82r having an inner surface 82i which is round and an outer surface which has a plurality of tooth shaped protrusion 82t formed thereon. Numeral 82s designates a round shaft formed on the outer surface of the round disc 82e and is used for mounting one end of the spring 85 thereon. The other end of the spring 85 is mounted on a shaft 11s formed on the inner surface of the other lower case portion 11b.

Another embodiment may have the shaft 11s formed on the cover 11a, and the pulley 82 mounted the other way around on the first shaft 15s, which would have simplified the assembly process of the wind up spring 85 inside the pulley 82.

Accordingly, manually pushing down on the push button 11e against the biasing spring 84, causes the arm 81 to swing about the second shaft 15p, which causes the tooth like wedge 81t to move away from the tooth shaped protrusions 82t, whereby the pulley 82 is released to allow the pulley 82 to rotate on the shaft 15s clock wise or counter clock wise to either allow the rope to be extended out of the apparatus 15 (i.e. due to the dog, not shown, leashed onto the end of the rope 11r pulling on the rope) or to be wound back up on the cylinder portion 82c between the discs 82d, 82e, due to the biasing force of the wind up spring 85. Accordingly, the dog leash extension/retraction apparatus disclosed herein is very simple in structure, requires very few parts and is very simple and easy to manufacture and assemble.

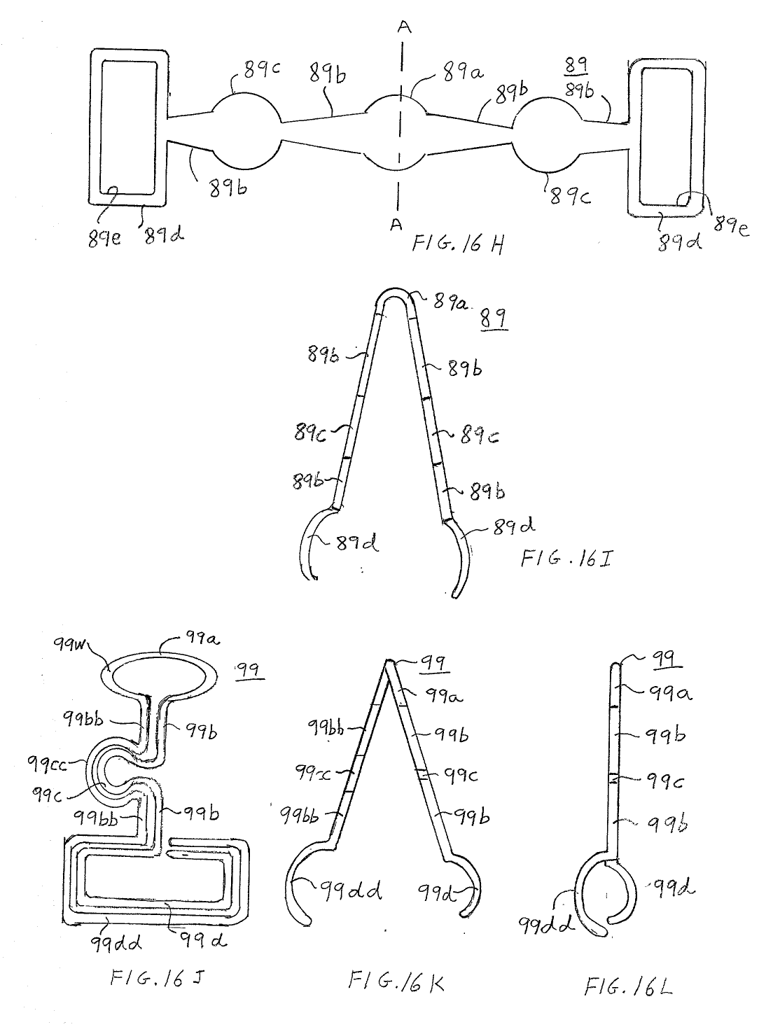

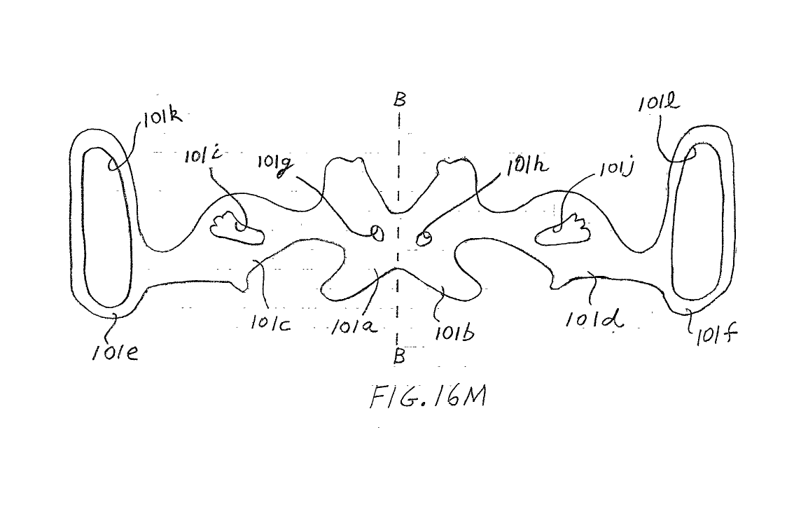

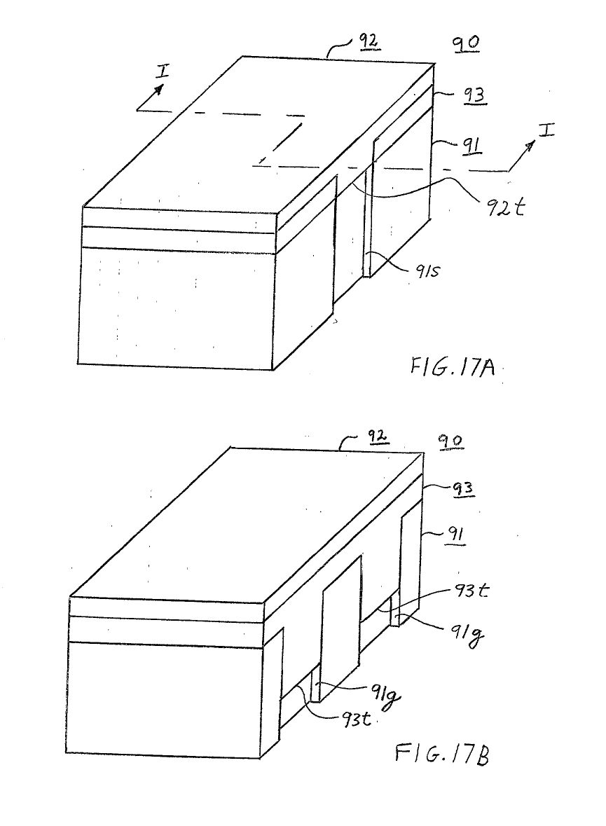

FIG. 16A shows a perspective view of a dog excrement scooper 69 for picking up dog excrement according to the present invention. FIGS. 16B and 16C show a side view and front view of the scooper 69 of FIG. 16A. The scooper 69 can be used in combination with the poly bag 20 to scoop up dog excrement. Referring to Figs., the dog scooper 69 comprises a flat round portion 69a having a hole 69h formed through the center thereof, two identically formed leg portions 69b, each leg portions 69b having one end thereof integrally formed along one side of the flat round portion 69a. Each leg portion 69b has a heart shaped protrusion 69c formed along the central portion thereof and a semi-cylindrical portion 69d formed along the other end thereof. The dog excrement picking up scooper 69 is formed of plastic or nylon using conventional injection molding techniques. The semi-cylindrical portions 69d each have a rectangular shaped hole 69e formed therethrough for reducing the weight thereof. The leg portions 69a each face each other and the distance between them is closest where they join with the round portion 69a and furthest at the semi-cylindrical portions 69d. Since the scooper 69 is made of plastic or nylon, the legs 69b each have a certain degree of resilience, whereby even when a person manually pushes the two legs towards each other by pressing on the heart shaped protrusions 69c (i.e. by placing their index finger on the outer surface of one hear shaped protrusion 69c and their thumb on the outer surface of the other heart shaped protrusion 69c and then moving the index finger towards the thumb), causing the semi-cylindrical portions 69d to move toward each other, as soon as the force on the legs 69b is decreased, the legs 69b move away from each other to their original positions as shown FIG. 16a. The two semi-cylindrical protrusions when pressed towards each other form an elliptical shape for facilitating the picking up of dog excrement since dog excrement is generally round in cross section. Furthermore, all the corners of the scooper 69 and especially the corners of the semi-cylindrical portions 69d are rounded (i.e. have no sharp corners) to minimize the possibility of the scooper piercing a hole through the poly bag it is placed in during the dog excrement picking up operation. Further, the scooper 69 is shown in real size, namely it is quite small to minimize the cost and to facilitate the storage thereof.

It should be noted it is not intended to limit this invention to the dog excrement picking up scooper shown in FIG. 16A and that many variations thereof can be realized without departing from the spirit of the invention.

FIG. 16D and FIG. 16E show a front view and an end view of a dog excrement scooper 690 having the profile of a dog on a pair of skates according to the present invention. Referring to the Fig., the round portion 69a has been changed to a flat portion 690a having the profile of a dogs' head. The flat portion 690a has a through hole 690h which is representative of a dog's eye, an elliptically shaped protrusion 690r which is representative of a dogs' ear and a round protrusion 690n which is representative of a dogs' nose. The two leg portions 69b have been changed to two flat portions 690b having the profile of a dog's body. The flat portions 690b each have a through hole 690f in the shape of a dog's foot and an elliptically shaped protrusion 690t representative of a dog's tail. The two semi-cylindrical portions 69d have been changed to two semi-cylindrical portions 690d having the profile of ice skates. The semi-cylindrical portions 690d each have an elliptically shaped through hole 690e formed therethrough. Accordingly, pushing on the two portions 690b towards each other using a persons thumb and index finger, the semi-cylindrical portions 690d move towards each other, whereby, by placing the scooper 690 inside a poly bag 20 and placing the poly bag 20 over a piece of excrement on the ground with the dog excrement between the semi-cylindrical portions 690d, the dog excrement can be grabed and picked up of the ground by the portions 690d, and then the poly bag 20 can be turned inside out to store the dog excrement therein. Then, the pressure on the scooper 690 is reduced to release the dog excrement (not shown) and then the scooper 690 is removed from the poly bag 20, so that it may be used the next time it is required. This shape of dog excrement picking up scooper 690 is very cute, and hopefully will encourage young people to pick up their dog's excrement while walking their dog instead of just living it their on the sidewalk.

It should be noted that the scooper 690 may be formed to resemble many cartoon characters, such as Snoopy or any other dog character on a pair of roller blades, Snoopy on a snow board, Snoopy with Nike running shoes, etc.

FIG. 16F shows a perspective view of a scooper support 79 according to the present invention. FIG. 16G shows an end view of the scooper support 79 supporting the scooper 69 therein. Referring to the Figs., the support 79 comprises a substantially semi cylindrical body having a round inner wall 79a and a at least one flat outer surface 79b, so that it may be mounted on the outside of a dog leash storage extension apparatus 15 using a strip of tape having an adhesive material on both sides thereof (not shown). The support 79 is formed of plastic using conventional injection molding techniques or extrusion techniques. Referring to the 16G, since the scooper support has a round inner surface, the diameter of which is slightly greater than the diameter of the pair of semi-cylindrical portions 69d, the semi-cylindrical portions 69d can be mounted in the support 79 by first pressing the legs 69b towards each other and then sliding the semi-cylindrical portions 69d into the inside of the support 79 by sliding the cylindrical portions 69d through the openning between the ends 79e in the support 79. Since the legs portions 69b of the scooper 69 are made of a material having an elastic nature, the leg portions 69b always try to return to their original spread apart shape as shown in FIGS. 16B and 16E. Accordingly, a constant force is exerted by the by the semi-cylindrical portions 69d on the inner surface 79a of the support 79, thereby locking the scooper 69 is a stored state inside the support 79. Accordingly, the support 79 provides a very cheap, simple, light and easy to use structure that can easily be mounted on the outer surface of conventional dog leash storage extension apparatuses 15 presently available on the market. The outer wall 79b is made flat so that it can be mounted on the outer wall of the apparatus 69 using a double sided adhesive tape which could be provided with the support 79 at the time of sale.

FIGS. 16H and 16I show a front view and an end view of a scooper 89 according to another embodiment of the present invention. The scooper 69 is formed using conventional cold pressing techniques, namely using high pressure to cut holes or given shapes in a sheet of metal or plastic. This method of forming various products is well known in the art and is a very cheap and quick way of manufacturing products since it simply requires stamping out multiple parts our of a flat sheet of metal or plastic.

Referring to FIG. 16H the scooper 89 is punched out of a 0.1-0.3 milimeter flat sheet of stainless steel in the shape shown in the Fig. Namely, the scooper 89 comprises two parts which are an image reflection of each other on both sides of a line A-A. The scooper 89 comprises a round middle portion 89a, two leg portions 89b formed on either side of the middle portion 89a, two round portions 89c each formed along a central part of each leg portion 89a and two rectangular portions 89d, each having a rectangular through hole 89e formed through the center thereof, each rectangular portion 89e formed on the extending ends of each leg portion 89b. After the scooper 89 is punched out of a sheet of metal as shown in FIG. 16H, it is bent to the shape shown in FIG. 16I using a conventional bending machine well known in the art. Accordingly, a very simple and cheap scooper is realized using this process of manufacture.

FIG. 16J shows a front view of a scooper 99 according to another embodiment of the present invention. FIGS. 16K-16L show end views of the scooper 99 of FIG. 16J in its natural state and in a pressed state, respectively. Referring to the Figs., the scooper 99 comprises a round wire of stainless steel which has been bent to the shape shown in FIGS. 16J and 16K. Referring to the Figs., the wire 99w is first bent in the x-y plane (i.e. from a Cartesian mathematical coordinate system) to have a elliptical central portion 99a, two leg portions 99b, 99bb, two semi round portions 99c, 99cc and two rectangular portions 99d, 99dd, the portions 99a, 99b and 99b, either being shorter or smaller than the portions 99aa, 99bb and 99cc, so that the portions 99a, 99b and 99b fit next to or inside of the portions 99aa, 99bb and 99cc when the portions 99a, 99b and 99b are pressed towards the portions 99aa, 99bb and 99cc (i.e. as shown in FIG. 16J), thereby realizing an extremely thin, cheap and light scooper, which requires very little storage space. After bending the wire 99w as described above, the elliptical portion 99a is twisted in the z coordinate direction, so that the leg portion are slightly apart as shown in FIG. 16K. To use the scooper 99, the user simply places his or her index finger and thumb on the round portions 99c, 99cc, respectively, and presses the finger towards the thumb to move the rectangular portions 99d and 99dd towards each other. Releasing the round portions 99c, 99cc allows the scooper legs 99b, 99bb and the square portions to return to their spread apart position as shown in FIG. 16K.

FIG. 16M shows a front view of a pooper scooper 101 according to another embodiment of the present invention. The scooper 101 and the scooper 89 shown in FIG. 16H are manufactured in exactly the same way and the only difference between them is that they have a different profile. Referring to the Fig., the scooper 101 is punched out of a 0.1-0.3 milimeter flat sheet of stainless steel or a flexible plastic or nylon in the shape shown in the Fig. Namely, the scooper 101 comprises one flat sheet having a profile representative of two dogs which are joined to each other at the top of their respective heads, i.e. the two dogs having an image reflection of each other on both sides of a line B-B. Referring to FIG. 16M the scooper 101 comprises two identically formed head portions 101a, 101b which are joined to each other along one end thereof, two identically formed body portion 101c, 101d, each of which has one end thereof joined to a respective head portion 101a, 101b, respectively, and two identically formed feet portions 101e, 101f each of which has one end thereof joined to a respective other end of the body portion 101c, 101d, respectively. The head portions 101a, 101b, the body portions 101c, 101d, and the feet portions 101e, 101f in profile look like the head, body and feet of a dog, respectively. Numeral 101g, 101h designate round holes punched out of the flat sheet at the same time the scooper 101 was punched out of the sheet of metal or plastic, and are representative of a dog's eyes in the head portions 101a, 101b. Numeral 101i, 101j designated two holes punched out in the center of the body portions 101c, 101d, respectively, and have a profile of a dog's front feet. Numerals 101k, 101l designate two holes punched out in the center of the feet portions 101e, 101f, respectively and in profile look like a pair of ice skates on a dog's feet. After the scooper 101 is punched out of a sheet of metal or plastic or nylon to have a profile as shown in the FIG. 16M, it is bent at line B-B so that the head and body and feet protions 101a, 101c, 101e and 101b, 101d,101c face each other with the feet portions 101e, 101f being at a distance from each other sufficient to grab a piece of dog sheet therebetween, i.e. about 5 cm. The feet portions 101e, 101f may be pressed to have semi cylindrical shapes, similar to the leg portions 69d of the scooper 69, so that the feet portions may be used to grab dog sheet more effectively. Accordingly, the scooper 101 can be made very cheaply, and may have any profile desired representitive of any dog such as a poodle, a bolldog, etc., or any cartoon figure such as snoopy, mickey mouse, etc.

Accordingly, the scoopers as shown in FIGS. 16A-16M can be manufactured cheaply and are compact, light and attractive, and accordingly, hopefully will induce kids and adults alike to pick up their dog's sheet, instead of just leaving it their for other people to step on.

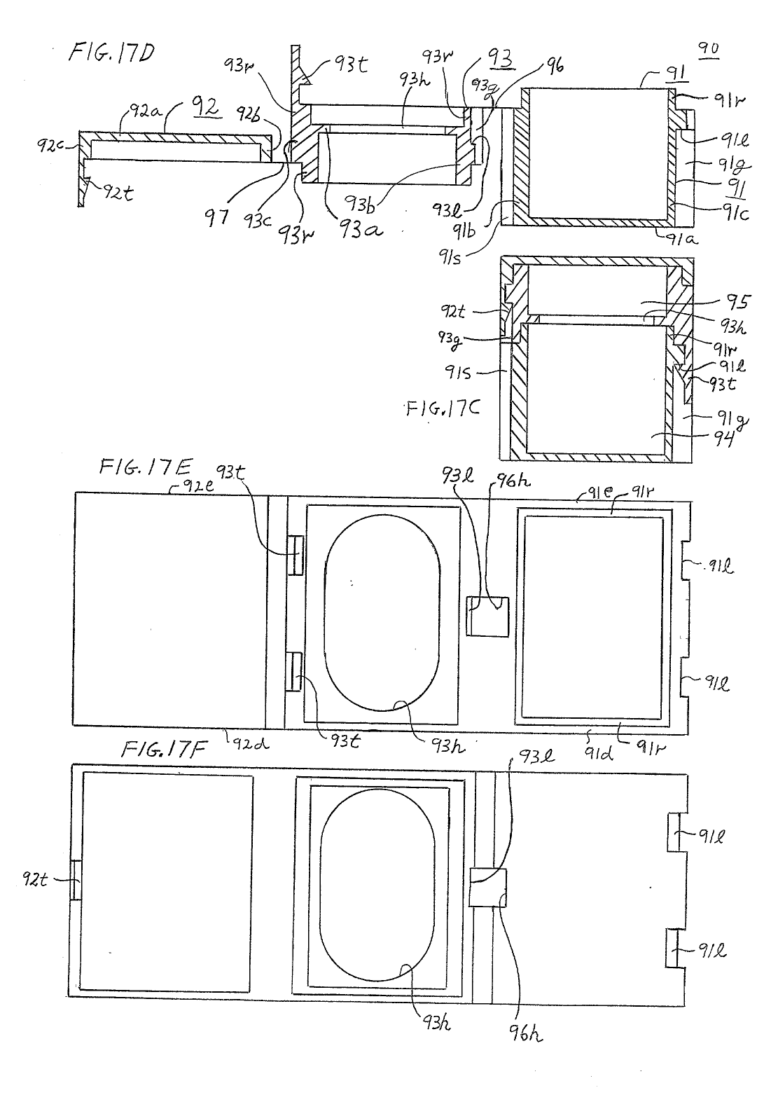

FIG. 17A shows a front perspective view of a storage-dispensing device according to another embodiment of the invention. FIG. 17B shows a back perspective view of the storage-dispensing device of FIG. 17A. FIG. 17C shows a cross sectional view at line I-I of FIG. 17A of the storage-dispensing device, the device being in a closed position. FIG. 17D shows a cross sectional view at line I-I of FIG. 17A of the storage-dispensing device, with the cover and divider portions thereof in the open position. FIG. 17E shows a top view of the storage-dispensing device with the cover and divider portions thereof in the open position. FIG. 17F shows a bottom view of the storage-dispensing device 90 with the cover and divider portions thereof in the open position.

Referring to FIGS. 17A-F, numeral 90 generally designates a storage-dispensing device for storing the poly bag pack 40 in one compartment 94 thereof and for dispensing the poly bags 20 in the pack 40 through another compartment 95 thereof according to the present invention. The storage device 90 comprises a first container portion 91, having the shape of a rectangular container, for storing the poly bag pack 40 in, a second cover portion 92, having the shape of a rectangular cover for closing the open side of a divider portion 93, the divider portion 93 dividing the device 90 into two compartments 94, 95 and allowing for the dispensing of poly bags therethrough.

The container portion 91 comprises a rectangular shaped flat bottom section 91a, a first long side walls 91b, a second long side wall 91c and two short side walls 91d and 91e, said side walls 91a-d being integrally formed with the outer periphery of the bottom section 91a along the bottom edges thereof and together define the shape of a rectangular container. Numeral 91r designates a ridge formed along the extending edges of the walls 91b-91d, which fit inside a ridge 93r of the divider section when the device is in the closed position, thereby providing a water tight seal therebetween. The container portion 91 further comprises a female latch section 91l, namely, the wall 91c has a square groove 91g formed along the bottom middle section thereof for receiving a male latch portion 93t integrally formed with the divider portion 93 therein.

The cover portion 92 comprises a rectangular shaped flat top section 92a, a first long side wall 92b, a second long side wall 92c, and two short side walls 92d and 92e, said side walls 92b-92e being integrally formed along the outer periphery of the top section 92a and together define the shape of a rectangular cover. Numeral 92t designates a male latch section, which comprises a tooth like protrusion integrally formed along a central bottom edge of the long side wall 92c. Accordingly, when the cover portion 92 is in the closed position, the male latch 92t latches onto the inside of the female latch portion 93l, to close the device 90.

Numerals 91r designates a ridges formed on the extending edges of the walls 91a-91d of the container portion 91. When the device 90 is in a closed position (i.e. as shown in FIG. 17C), the ridges 91r and 93r line up against each other, thereby making the device water proof, so that rain water will not get into the device when the user is walking his or her dog outdoors.

The divider portion 93 comprises a rectangular flat section 93a having an elliptically shaped hole 93h formed through the center thereof. Numeral 93r designates a ridge integrally formed along the top side and along the periphery of the flat section 93a. Numeral 93c designates a rectangular wall formed along the bottom periphery of the flat section 93a. The ridge 91r and the ridge 93r have the same profile and are in line with each other when the divider 93 is in the closed position (i.e. as shown in FIG. 17C), so that they overlap and provide for a water proof device. Numeral 93t designate a pair of male latch portions in the form of two tooth like protrusions formed along the extending edge of the ridge 93r. The male latch portions 93t fit into corresponding grooves 91g formed along the outer side of the long wall section 91c of the container portion 91 to latch in corresponding female latch portions 91l formed in the container 91. Numeral 93g designates a groove and numeral 93l designates a female latch portion formed in the wall 93b of the divider portion 93.

The device 90 is made of plastic such as polypropiline or nylon using conventional injection molding techniques.

Numeral 96 designates a flexible thin strip of plastic (hereinafter referred to as a hinge 96) the respective sides of which are integrally formed along the respective extending edges of the long walls 91b and the ridge 93r, thereby, not only joining the container portion 91 to the divider portion 93, but also providing a hinge function for allowing the divider portion 93 to pivot from a closed position to an open position with respect to the container portion 91.

Numeral 97 designates a flexible thin strip of plastic (hereinafter referred to as hinge 97) the respective sides of which are integrally formed along the respective extending edges of the long walls 92b and 93c, thereby, not only joining the divider portion 93 to the cover portion 92, but also providing a hinge function of allowing the cover portion 92 to pivot from a closed position (i.e. as shown in FIG. 17C) to an open position (i.e. as shown in FIG. 17D), with respect to the divider portion 93. The hinges 96, 97 are well known in the art of plastic injection molding techniques and are extensively used in plastic boxes.

Numeral 96h designates a square hole formed through a central portion of the hinge 96. The reason for the square hole 96h is to facilitate the forming of the groove 93g and the female latch portion 93l during the injection molding stage of manufacturing the device 90.

Accordingly, the device 90 comprises three portions, namely a container portion 91, a divider portion 93 and a cover portion 92 which are joined to each other by hinge 96 and hinge 97, respectively. The device 90 can be manufactured using conventional injection molding techniques. The device 90 folds up and opens up like an accordion when closing or opening it. Namely, to close the device 90, the cover portion 92 swings counter clock wise with respect to the divider portion 93 and the divider portion 93 swings clock wise with respect to the container portion 91. When placing a pack 40 of poly bags 20 inside the device 90, the user simply pulls outwardly on the pair of male latch portions 93t to open the container portion 91. At this time the cover portion 92 can stay in a closed position with respect to the divider portion 93, since the cover portion 92 does not interfere with the opening or closing of the divider portion 93 with respect to the container portion 91. Next, the divider portion 93 is closed with respect to the container portion 91. Next, to remove a poly bag 20 from inside the pack 40 stored in the container portion 91, the user opens the cover portion 92 with respect to divider 93 by pulling on the latch 92t and pulls a poly bag 20 out of the pack 40 by pulling it through the opening 93h.

FIG. 18 shows a perspective view of the poly bag pack storage-dispensing device 620 having a pooper scooper support integrally formed therewith and having the pooper scooper apparatus 690 shown in FIG. 16D mounted therein. Referring to the Fig. it can be seen that the device 620 is substantially the same as the device 60 shown in FIG. 13A, and accordingly, the same numerals and the same symbols will be used to designate the same or similar parts. Only the parts in the device 620 which are different from the device 60 will be described. Numeral 621 desigates a pooper scooper compartment formed along a part of the outer wall 62a at one end of the device 62. The compartment 621 comprises an upper wall 621a and side walls 621b integrally formed with said upper wall 621a and the outer surface of the outer wall 62a along the periphery thereof. The side walls 621b, upper wall 62a and wall 621a together form a cylindrical shaped opening 621c for allowing the two semi-cylindrical portions 690d of the scooper 690 to pass therethrough, so that the portions 690d can be supported therein. Numeral 621p designates round protrusions formed along an inner side of the wall 621b along the extending end thereof. The protrusions 621p prevent the leg portions 690d from sliding out of the compartment 621. The scooper 690 has the head portion 690a thereof partly extend past the end of the device 620 when the leg portions 690d are completely inserted into the compartment 621, so that it is easily accessible to manually grab unto by a persons hand and used to manually pull the scooper 690 out of the compartment 621. Accordingly, the scooper 690 being mounted inside the compartment 621 on the device 620 does not hinder with the function of the device 620 during the removal of a poly bag from inside of the device 620 and provides for a very convenient and quick access to the scooper 690 when it is required. Furthermore, since the scooper would be used in combination with a poly bag to pick up dog excrement, this combination of having the poly bags and the scooper stored inside and on the outside of one device 621 provides a great convenience and solves a great problem faced by dog owners. Still further, since the leg portions 690d of the scooper 690 are completely encased inside the compartment 621, a hygienic environment is created. It should be noted that any of the other pooper scoopers disclosed herein can be mounted inside the compartment 621 similar to the way the scooper 690 is mounted.

It should be noted that the use of the poly-bag-pack of the present invention is not intended to be limited to picking up dog excrement only, and that it may be used for many other applications. One such other use can be for babies. Mother's often have to change babies diapers and keep the soiled diapers with them until they can dispose of them. The poly-bag-pack of the present invention could be very useful for such mothers, since they can store the pack in their pocket or their bag and use the poly bags stored therein as needed. Another use could be for older people who can not control their bowel movements and use diapers. They also could use the poly-bag-pack as need. These are just a few of the possible uses and many more will become apparent as the poly-bag-pack becomes available on the market, such as on airplanes in the toilet compartment, etc.

It should be noted that the embodiments discloses above are not intended to limit this invention thereto, and that various variations may be made without departing from the spirit and scope of the present invention.

What is claimed is:

1. A pack of poly bags comprising:
a plurality of poly bags, each of said poly bags being folded at least once along the width direction thereof and at least once along the length direction thereof, said folded poly bags being stacked on top of each other; and
a cover for wrapping around said folded poly bags, said cover being formed of a thin film and having an opening for allowing said folded poly bags to be pulled out therethrough, each folded poly bag automatically unfolding itself along the length direction thereof as it is being pulled out of said opening in said cover and each poly bag coming out of said opening in said cover with the open end thereof first.

2. A pack of poly bags as defined in claim 1, wherein:
said poly bags are joint to each other along the width direction thereof and have perforated lines formed along the width direction of each poly bag for facilitating the tearing apart of each poly bag from an adjacent poly bags, each folded poly bag automatically unfolding itself along the length direction thereof as it is being pulled out of said opening in said cover, so that the bag pulled out of said cover can be easily torn away at the perforated line from the bag adjacent to it, even though the pulled out bag is still folded along the width direction thereof, since the perforated line of the still partly folded bag overlap in a straight line.

3. A pack of poly bags as defined in claim 2, wherein:
said poly bags in said cover are folded twice along the width direction thereof and then at least 3 times along the length direction thereof, thereby requiring much less surface area as compared to the normal size of the bags.

4. A pack of poly bags as defined in claim 1, wherein:
said folded bags in said plurality of bags are stacked on top of each other with each of said folded bags having a last folded portion thereof tucked into a first folded portion of an adjacent bag, so that pulling out a thus folded poly bag out of said pack, causes the bag being pulled out of said cover to not only automatically unfold along the length direction thereof as it is coming out of said opening in said cover, but also causes the first folded portion of an adjacent bag to the bag being pulled out to also come out of said opening in said bag, said bags coming out of said pack with the open ends thereof coming out first.

5. A pack of poly bags as defined in claim 4, wherein: said poly bags in said cover are folded twice along the width direction thereof and then at least 4 times along the length direction thereof.

6. A pack of poly bags as defined in claim 1, wherein said poly bags are 250 milimeters wide and 300 milimeters long.

7. A method of storing a plurality of poly bags in a substantially smaller vinyl cover comprising the steps of:
folding each of said poly bags along the width thereof at least once;
folding each of said poly bags along the length thereof at least once;
stacking the folded poly bags on top of each other with a last folded portion of one bag tucked into a first folded section of an adjacent poly bag and so on, so that when a poly bag is pulled out an opening in said cover, a portion of an adjacent bag to the bag being pulled out is also pulled out of said cover.

8. A storage-dispensing device for housing a pack of poly bags therein and for sequentially dispensing the poly bags stored in said pack of poly bags one at a time, which comprises:
a container portion for storing said pack of poly bags therein;
a cover portion for closing an open side of said container portion;
a divider portion for separating said container portion and said cover portion into two compartments, said divider portion having a through hole formed through the center thereof for allowing poly bags stored in said pack of poly bags stored in said container portion to be sequentially pulled out through said through hole in said divider portion; and
means for joining said container portion, cover portion and divider portion to each other.

9. A storage-dispensing device as claimed in claim 8, wherein said joining means comprises:
a first flexible hinge joining said container portion to said divider portion; and
a second flexible hinge joining said container portion to said cover portion, said portions and said hinges being integrally formed with each other.

10. A storage-dispensing device as claimed in claim 8, wherein said joining means comprises:
a first flexible hinge joining said container portion to said divider portion,
a second flexible hinge joining said cover portion to said divider portion, said portions and said hinges being integrally formed with each other.

11. A storage dispensing device as claimed in claim 8, wherein said container portion of said device is integrally formed with a case portion of a dog leash storage-extention apparatus, said divider portion comprising mounting means for mounting said divider portion in said container portion and said cover portion comprising mounting means for mounting said cover portion on said dog leash case portion, and a hinge portion integrally formed with said cover portion mounting means and said cover portion, so that said cover can swivel to open and close said container portion.

12. A storage dispensing device as claimed in claim 8, wherein said divider portion further comprises a plurality of finger like flexible protrusions integrally formed therewith, said protrusions extending from the periphery of said hole partially into the center of said hole, said protrusion preventing a portion of a next available bag extending through said hole and between said protrusions from falling back into said container portion, thereby ensuring that the extending end of a next available bag is accessible once said cover portion is opened.

13. A storage dispensing device as claimed in claim 8, further comprising:
means for mounting a scooper pooper for picking up dog excrement, said mounting means being integrally formed with said device.

14. A dog leash extending-retracting apparatus, which comprises:
a lower case portion;
an upper case portion;
means for connecting said upper and lower case portions to each other;
a rope extension retraction device;
means for mounting said rope extension-retraction device between said upper and lower case portions;
biasing means for keeping a rope wound on said rope extension-retraction device in a wound up state inside said apparatus;
activation means for allowing said rope to be extended through a hole formed at one end of said case portions out of said apparatus; and
a poly bag pack storage-dispensing means integrally formed with said apparatus for storing a pack of poly bags containing a plurality of folded poly bags in one compartment thereof and for dispensing said folded poly bags through another compartment thereof.

15. A dog leash extending retracting apparatus as defined in claim 14, wherein:
said poly bag pack storage-dispensing means comprises:
a container portion integrally formed with said upper case portion for storing a pack of poly bags therein, the container portion extending from the inner surface of said lower case portion to the outside surface of said upper case portion;
a cover portion for closing and opening an opening in said container portion;
mounting means for mounting said cover on said upper case portion;
a divider portion having a through hole formed through the center thereof for allowing poly bags stored in said pack of poly bags to pass therethrough; and
means for mounting said divider portion inside said container portion.

16. A dog leash extending retracting apparatus as defined in claim 14, wherein:
said poly bag pack storage-dispensing means comprises:
a container portion integrally formed with said lower case portion for storing a pack of poly bags therein, the container portion extending from the inner surface of said lower case portion to the outside surface of said upper case portion;
a cover portion for closing and opening an opening in said container portion;
mounting means for mounting said cover on said upper case portion;
a divider portion having a through hole formed through the center thereof for allowing poly bags stored in said pack of poly bags to pass therethrough; and
means for mounting said divider portion inside said container portion.

17. A scooper for picking up dog excrement in combination with a poly bag, which comprises:
two leg portions; and
means for joining one end of said leg portions to each other, said leg portions and/or said joining means being formed of a resilient material so that the other ends of said leg portions return to a given position apart from each other after being pushed towards each other for the purpose of grabbing a piece of dog excrement therebetween.

18. A scooper for picking up dog excrement as defined in claim 17, wherein:
said joining means comprises a flat portion, one end of said leg portions being integrally formed with said flat portion, each leg portion comprising a protrusion formed along a central portion thereof and a semi-cylindrical portion formed along the other end thereof, said leg portions facing each other, the distance between said leg portions being smallest where said leg portions join with said flat portion and furthest at said semi-cylindrical portions, said leg portions being formed of a resilience material, so that said leg portions return to their original position after being pushed towards each other.

19. A scooper for picking up dog excrement as defined in claim 18, wherein said scooper is formed using conventional injection molding techniques, said flat portion and said leg portions having a profile which resembles a dog or a famous cartoon character.

20. A scooper for picking up dog excrement as defined in claim 17, wherein said joining means and said leg portions are formed of a flat sheet of resilient metal or plastic, said flat sheet being stamped out of a larger sheet and having a central portion thereof curved so that the portions of said flat sheet extending away from said curved central portion define said two legs and said curved portion define said joining means, said leg portions being furthest from each other at the extending ends thereof.
